(19) United States
(12) Patent Application Publication
(10) Pub. No.: US 2024/0301914 A1
(43) Pub. Date: Sep. 12, 2024

(54) BEARING BUSH

(71) Applicant: Sumitomo Riko Company Limited, Komaki-shi (JP)

(72) Inventor: Jozsef KONDOR, Künzell (DE)

(73) Assignee: Sumitomo Riko Company Limited, Komaki-shi (JP)

(21) Appl. No.: 18/585,555

(22) Filed: Feb. 23, 2024

(30) Foreign Application Priority Data
Mar. 8, 2023 (DE) 10 2023 105 719.7

(51) Int. Cl. F16C 33/12; F16C 17/02; F16C 33/14

(52) U.S. Cl. CPC F16C 33/125; F16C 17/02; F16C 33/14

(57) ABSTRACT

A bearing bush and a method of manufacturing a bearing bush is provided. The bearing bush may be used in a transverse control arm. The bearing bush includes an inner sleeve; an outer sleeve arranged radially around the inner sleeve; an elastomer body arranged between the inner sleeve and the outer sleeve; and an intermediate sleeve which is, at least in sections, embedded in the elastomer body. The outer sleeve has, at its axial ends, a radially inwardly bent bend portion; wherein a radial outer surface of the intermediate sleeve has a radially outwardly directed bulge along the axial direction of the bearing bush. The intermediate sleeve has a radially outwardly protruding outer stop portion which forms an axial stop with respect to an axial inner surface of the bend portion of the outer sleeve.

### CROSS-REFERENCE TO RELATED APPLICATIONS

This application claims priority of German Patent Application No. 10 2023 105 719.7 filed on Mar. 8, 2023, the contents of which are incorporated herein.

### TECHNICAL FIELD

The present disclosure relates to a bearing bush, in particular for a transverse control arm of a vehicle, and to a method for manufacturing a bearing bush, in particular for a transverse control arm of a vehicle.

### BACKGROUND

From the prior art, various bearing bushes are known. Here, individual conventional bearing bushes use an outer sleeve in addition to an inner sleeve, wherein an elastomer body is arranged between the inner sleeve and the outer sleeve. In this case, one of the inner sleeve and the outer sleeve serves for linking to an element to be supported, and the other of the inner sleeve and the outer sleeve serves in particular for linking to a portion of a vehicle body. Conventional inner sleeves, in particular for vertical transverse control arm bushes, comprise in particular a contour for forming a ball joint, whereby the inner sleeve influences the kinematic properties and damping properties in the corresponding spatial directions. Furthermore, it is known in the prior art to arrange intermediate sleeves between the inner sleeve and the outer sleeve to further influence the damping properties of the bearing bush. In this case, conventional intermediate sleeves are frequently configured as a bent sheet metal part which has a substantially constant wall thickness along the axial direction, whereby they can be produced comparatively easily and cost-effectively.

Bearing bushes for transverse control arms are subject to various stiffness and characteristic curve requirements, and secure in particular a driving stability during driving, wherein in particular from the steering behavior, acceleration, braking and the general contact between the wheel and the road, various loads act on the transverse control arm and the bearing bush arranged thereon.

Therefore, it is an object of the present disclosure to provide a bearing bush, in particular for a transverse control arm of a vehicle, which allows for a particularly targeted influence on stiffnesses, characteristic curves and damping properties.

### SUMMARY

The object is achieved by the subject matter of the independent claims. Preferred embodiments are specified in the dependent claims.

A first aspect of the disclosure relates to a bearing bush, in particular for a transverse control arm of a vehicle, having: an inner sleeve; an outer sleeve which is arranged radially around the inner sleeve; an elastomer body which is arranged between the inner sleeve and the outer sleeve and elastically connects them to each other; and an intermediate sleeve which is, at least in sections, embedded in the elastomer body; wherein the outer sleeve has, at its axial ends, a radially inwardly bent bend portion, respectively; wherein a radial outer surface of the intermediate sleeve has a radially outwardly directed bulge along the axial direction of the bearing bush, and wherein the intermediate sleeve has a radially outwardly protruding outer stop portion which forms an axial stop with respect to or opposing an axial inner surface of the bend portion of the outer sleeve.

The present bearing bush advantageously allows, in particular by means of the axial stop which the radially outwardly protruding outer stop portion provides with respect to the axial inner surface of the bend portion of the outer sleeve, that the damping properties and the kinematic properties of the bearing bush are in particular adjustable in a targeted manner in the axial direction, and that in particular a relative deflection between the intermediate sleeve and the outer sleeve is advantageously limited. In other words, by means of the axial stop, advantageously a first region of an elastic deformation of the bearing bush may be adjusted, which region is determined substantially by the elastomer body, and from a certain axial deformation, wherein the axial inner surface of the bend portion of the outer sleeve touches the radially protruding outer stop portion, a second region, contiguous with the first region, of an elastic deformation of the bearing bush may be adjusted, which region is determined substantially by the contact between the intermediate sleeve and the outer sleeve. In other words, the axial stop advantageously allows to substantially limit the movement of the bearing bush to a predetermined region of force-path characteristic curves, which are defined by the bearing bush, in the respective spatial directions. Thus, the damping properties and the kinematic properties of the bearing bush in the event of a load on the bearing bush may advantageously be adjusted in a targeted manner.

In other words, the axial inner surface of the bend portion of the outer sleeve in particular relates to a surface of the outer sleeve arranged at the axial ends of the outer sleeve and facing the intermediate sleeve. The axial inner surface is therefore in particular arranged on a radial inner side of the outer sleeve. The bend portion may project radially inwards by about 5% to about 40%, 10% to about 35% or about 15% to about 30% of the largest radial distance between the inner sleeve and the outer sleeve.

The radially outwardly protruding outer stop portion of the intermediate sleeve is in particular a portion which protrudes radially outwards relative to the radially outwardly directed bulge of the intermediate sleeve.

Furthermore, the intermediate sleeve, by adjusting the radially outwardly directed bulge along the axial direction and the associated adjustment of the geometry of the elastomer body, allows to adjust the radial stiffness of the intermediate sleeve and thereby the damping properties of the bearing bush in a targeted manner in cooperation with the elastomer body, and to define the force-path characteristic curves of the bearing bush in the respective spatial directions. By the intermediate sleeve preventing the presence of the elastomer body at targeted locations between the inner sleeve and the outer sleeve by its shape, that is, by its volume, the stiffness properties of the bearing bush and thereby furthermore the damping properties of the bearing bush may advantageously be adjusted in a targeted manner for the bearing bush by adjusting the shape and in particular the radially outwardly directed bulge of the intermediate sleeve.

Furthermore, by means of the radially outwardly directed bulge, the intermediate sleeve is advantageously provided with a crowned shape which is in particular arranged or formed centrally in the axial direction on the intermediate sleeve. This advantageously leads to a low cardanic stiffness and a low torsional stiffness of the bearing bush while at the same time the radial stiffness is comparatively high due to the intermediate sleeve.

The adjustable radial stiffness, cardanic stiffness and torsional stiffness, in particular with a comparatively low cardanic stiffness and comparatively low torsional stiffness, as well as the associated adjustment of the force-path characteristic curve(s) of the bearing bush, are advantageous in particular in bearing bushes of a transverse control arm such as radius arm bearings, for example, since the transverse control arm is subject to a plurality of loads and vibrations during driving such as, in particular, by the contact between the wheel and the road, especially during braking, when accelerating and in steering operations, so that thereby the traveling behavior and traveling comfort can advantageously be influenced in a targeted manner. The present bearing bush may accordingly be in particular a radius arm bearing bush.

In bearing bushes which are arranged on a transverse control arm body and the axial direction of which is substantially parallel to the height direction of the vehicle, the cardanic stiffness and the torsional stiffness may constitute so-called parasitic stiffnesses which, in other words, are not desired and therefore are to be reduced as far as possible for improved driving-dynamic properties. By virtue of a comparatively high radial stiffness and, at the same time, a comparatively low cardanic stiffness and low torsional stiffness, forces acting on the transverse control arm may advantageously be received well in the horizontal plane, and vibrations in a cardanic direction and torsional direction may be damped well.

The shape and in particular the radially outwardly directed bulge of the intermediate sleeve may in particular be adjustable by the production or by the manufacture of the intermediate sleeve. In this case, the curvature of the radially outwardly directed bulge, for example, may be adjustable along the axial direction. Additionally or alternatively, for example, the maximum radial extension of the radially outwardly directed bulge may be adjustable. Further additionally or alternatively, for example, the formation of the radially outwardly directed bulge may be adjustable along the circumferential direction of the bearing bush, in particular by the radially outwardly directed bulge being provided continuously along the circumferential direction, or being shaped in a contoured form along the circumferential direction, for example with alternating elevation portions and depression portions which vary in radius.

The intermediate sleeve of the bearing bush may in particular be produced or manufactured by means of injection-molding a plastic or a fiber-reinforced plastic, by means of die-casting a metal such as aluminum, for example, or by means of 3D printing, whereby the intermediate sleeve may advantageously be produced or manufactured with a corresponding contour or shape according to the limits of the respective production method or manufacturing method. Thus, by producing or manufacturing the intermediate sleeve with a predetermined contour, the stiffness properties, and thereby in turn the damping properties and in particular the force-path characteristic curves of the bearing bush, may be adjusted in a targeted manner. Furthermore, the intermediate sleeve having plastic or aluminum may in particular advantageously reduce the risk of corrosion of the bearing bush.

In particular, the bearing bush may have a standardized and in particular substantially cylindrical inner sleeve and/or outer sleeve, whereby the bearing bush can be basically manufactured in an easy and efficient manner, while at the same time the stiffness properties, and thereby the damping properties, of the bearing bush may be adjustable in a targeted manner by means of the intermediate sleeve. Thereby, despite the easy and efficient manufacture, an application-specific bearing bush may advantageously be provided. Even in a standardized outer sleeve, in particular by providing the outer sleeve with one or more bend portions, and/or by a radial deformation of the outer sleeve, the kinematic properties and the damping properties may advantageously be precisely adjusted in a simple manner. The elastomer body may abut against the axial inner surface of the bend portion without material fit, so that substantially no shear forces are transmitted from the axial inner surface of the bend portion to the elastomer body. The bend portion or portions thus advantageously increase the radial stiffness and the axial stiffness of the bearing bush, in particular without increasing the cardanic stiffness and the torsional stiffness of the bearing bush. At the same time, the bend portion or portions allow to relieve tensile stresses in the elastomer body and therefore to advantageously improve the service life of the bearing bush. Moreover, by means of the bend portion or portions, an axial stop may be adjusted relative to the intermediate sleeve, whereby the movement of the bearing bush may advantageously be kinematically limited to a predetermined region of a force-path characteristic curve of the bearing bush. Thus, by means of the bend portion or portions, the radial stiffness, the axial stiffness and the region of the bearing bush available in the force-path characteristic curve, in other words, in particular the kinematic properties and the damping properties of the bearing bush, may advantageously be precisely adjusted in a simple manner depending on the length of the bend portion, depending on the angle of the bend portion with respect to the axial direction, and depending on the bending radius.

The present bearing bush may in particular be a bearing bush of a transverse control arm for a vehicle, such as a radius arm bearing bush, for example. The outer sleeve of the bearing bush may adopt a maximum deflection or a maximum rotation in the torsional direction and/or maximum pivoting in the cardanic direction in the range of about −35° to about +35°, for example in the range of about −25° to about +25°, or in the range of about −15° to about +15° relative to the inner sleeve of the bearing bush, in particular without damaging the elastomer body.

The inner sleeve of the present bearing bush may in particular be an inner sleeve to be fixed to a vehicle body portion, which is fixable to the vehicle body portion by means of a pin, a bolt, a screw and/or a rivet, for example.

The outer sleeve of the present bearing bush may in particular be an outer sleeve to be fixed to the transverse control arm, in particular to a lower transverse control arm, which is fixable to the transverse control arm by means of press-fitting, adhesive bonding and/or in a form-fitting manner.

In exemplary embodiments of the bearing bush, the intermediate sleeve may have multiple radially outwardly protruding outer stop portions to further adjust the damping properties of the bearing bush in a targeted manner in predetermined spatial directions.

In preferred embodiments, the intermediate sleeve may have at least two radially outwardly protruding outer stop portions, wherein the at least two radially outwardly protruding stop portions may in particular be formed diametrically opposite one another in the circumferential direction on the intermediate sleeve.

The at least two radially outwardly protruding stop portions which are in particular arranged diametrically opposite one another, may be formed in the circumferential direction over an angular range of about 10° to about 90°, about 15° to about 60° or about 20° to about 40°, respectively.

In exemplary embodiments of the bearing bush, the radially outwardly protruding outer stop portion of the intermediate sleeve may form a radial stop with respect to a radial inner surface of the outer sleeve.

The radial inner surface of the outer sleeve in particular relates to a surface of the outer sleeve arranged between the axial ends of the outer sleeve and facing the intermediate sleeve and/or the inner sleeve. The radial inner surface of the outer sleeve is therefore in particular arranged on a radial inner side of the outer sleeve.

By virtue of the radial stop, a radial deflection between the outer sleeve and the intermediate sleeve may advantageously be additionally limited, and a possible damage to the bearing bush, in particular to the elastomer body of the bearing bush, due to an excessive relative deflection between the outer sleeve and the intermediate sleeve in the radial direction may be prevented.

In the region of the stop, a comparatively thin elastomer layer may be provided to decrease a direct wear and tear of the sleeves striking against one other while influencing the striking behavior only to a negligibly low extent. In this case, the elastomer layer, which may be formed contiguously with the elastomer body, may have a thickness in the range of about 0.2 mm to about 5 mm, in particular in the range of about 0.2 mm to about 3 mm, preferably in the range of about 1 mm to about 2 mm, in the region of a respective stop.

The bend portion or the bend portions of the outer sleeve may in particular be shaped such that the outer sleeve, at its axial end or at its axial ends, that is, at the axially outermost portion of the outer sleeve, respectively, is inclined with respect to the axial direction of the bearing bush, in particular radially inwardly inclined. The bend portion or the bend portions may be inclined relative to the axial direction of the bearing bush in a range of about 15° to about 90° on average, wherein the bend portions may also have a curvature.

Furthermore, various terms are used repeatedly, the understanding of which is intended to be facilitated by the following definitions.

Axial direction: The bearing bush constitutes a substantially cylindrical component which is rotationally symmetric at least in sections, for example at least with regard to a radially inner or outer surface of the inner sleeve, the intermediate sleeve or the outer sleeve. Accordingly, the axial direction constitutes in particular a direction which runs substantially along the axis along which the substantially cylindrical bearing bush extends.

Radial direction: The radial direction describes in particular a direction starting from an axis of the substantially cylindrical bearing bush, wherein the radial direction faces radially outwards, in particular towards an outer contour or lateral surface of the bearing bush or of an element of the bearing bush. The radial direction is in particular substantially perpendicular to the axial direction. A radial direction of the bearing bush designated in the present case as a first predetermined radial direction may, in the mounted state of the bearing bush to a transverse control arm and in particular to a vehicle, in particular be substantially parallel to the traveling direction of a vehicle.

Circumferential direction: The circumferential direction constitutes a direction which is substantially perpendicular to the axial direction and/or to the radial direction. The circumferential direction may in particular substantially correspond to a direction along a circumference of the inner sleeve, the intermediate sleeve and/or the outer sleeve. The circumferential direction may, in other words, in particular be similar to a circumferential direction of a cylinder, wherein the present bearing bush is not limited to a strictly cylinder-shaped contour.

The axial direction may in particular form a right-handed system, in particular a cylinder coordinate system, together with the radial direction and the circumferential direction.

If a direction or an angle is specified with the addition “substantially” or “approximately” or “about”, this addition is in particular intended to mean or to be understood as a deviation from the relevant direction or from the relevant angle in the range of 0° to 3°.

If a spatial dimension, a spatial ratio or another ratio is specified with the addition “substantially” or “approximately” or “about”, this addition is in particular intended to mean or to be understood as a deviation from the relevant dimension or from the relevant ratio in the range of 0% to 5%.

In preferred embodiments of the bearing bush, the inner sleeve may have a substantially constant cross-section along the axial direction.

Thereby, the inner sleeve may advantageously be manufactured easily and in particular cost-effectively. Furthermore, by virtue of the substantially constant cross-section, the inner sleeve is advantageously manufacturable by means of extrusion or continuous casting, which advantageously improves the production accuracy in comparison with die casting, especially in the case of high quantities, and decreases the process complexity for producing the inner sleeve as compared to die casting. Moreover, the efficiency in producing inner sleeves for bearing bushes may advantageously be improved.

For example, the inner sleeve may be substantially cylindrical. In other words, in exemplary embodiments, the inner sleeve may have at least one of a substantially constant inner diameter and a substantially constant outer diameter.

In preferred embodiments of the bearing bush, a radial inner surface of the intermediate sleeve may have a radially inwardly directed bulge along the axial direction of the bearing bush.

The radially inwardly directed bulge of the intermediate sleeve may in particular be an adjustable bulge, that is, in particular a bulge adjustable by means of the production of the intermediate sleeve.

Thereby, the stiffness properties may advantageously be adjusted, in particular by specifically producing or manufacturing merely the shape of the intermediate sleeve, and by using the inner sleeve and/or the outer sleeve as standard parts from a mass production, for example.

In preferred embodiments of the bearing bush, the intermediate sleeve may be directly connected to the inner sleeve, wherein the intermediate sleeve is in particular formed in one piece with the inner sleeve, or an elastomer layer, in particular an elastomer layer of the elastomer body, may be so thin between the intermediate sleeve and the inner sleeve that the intermediate sleeve is substantially rigidly connected to the inner sleeve.

In other words, in preferred embodiments, the intermediate sleeve may in particular be formed integrally with the inner sleeve, for example by means of casting or die casting of a metal such as aluminum or steel, or by means of injection molding of a plastic such as polyamide or fiber-reinforced polyamide, for example, such as, in particular, glass fiber-reinforced polyamide. Alternatively, the intermediate sleeve and the inner sleeve may be substantially rigidly connected by means of a thin elastomer layer. In this case, the thin elastomer layer may in particular have a thickness, that is, in particular a material thickness substantially in the radial direction of the bearing bush, which is in the range of about 0.2 mm to about 1.5 mm, preferably in the range of about 0.5 mm to about 1.2 mm. The elastomer body may in particular have or consist of natural rubber (NR), have or consist of synthetic rubber, have or consist of polyurethane (PUR), in particular casted polyurethane, have or consist of ethylene propylene diene rubber (EPDM) or have or consist of silicone or have or consist of a combination or a blend of at least two of the above-mentioned materials.

Here, the thin elastomer layer is used similarly to an adhesive, so that in the above-described thin elastomer layer, the intermediate sleeve and the inner sleeve are connected to each other almost rigidly or in other words, approximately rigidly.

While the separate production of the inner sleeve and the intermediate sleeve and the subsequent connection of the two by means of the thin elastomer layer advantageously allows for an improved freedom of design or creative freedom in particular of the intermediate sleeve, such as, for example, with regard to the shape of the intermediate sleeve and with regard to the material of the intermediate sleeve, the one-piece production of the intermediate sleeve with the inner sleeve allows for a production advantageously saving time and effort, that is, an advantageously efficient production of the bearing bush as a whole.

In preferred embodiments of the bearing bush, the intermediate sleeve may have a radially inwardly protruding inner stop portion which forms a radial stop with respect to a radial outer surface of the inner sleeve.

In exemplary embodiments, the intermediate sleeve may have multiple radially inwardly protruding inner stop portions. The one or more radially inwardly protruding inner stop portions may be arranged or formed to be distributed in the circumferential direction, in particular uniformly distributed in the circumferential direction, on the intermediate sleeve. Alternatively or additionally, the one or more radially inwardly protruding inner stop portions may be arranged or formed on the intermediate sleeve in a predetermined orientation along the circumferential direction, for example in accordance with the orientation of the one or more radially outwardly protruding outer stop portions. In other words, the one or more radially inwardly protruding inner stop portions may be arranged opposite one or, correspondingly, more of the radially outwardly protruding outer stop portions in a thickness direction of the intermediate sleeve.

The one or more radially inwardly protruding inner stop portions, which are in particular arranged or formed diametrically opposite one another, may be formed in the circumferential direction over an angular range of about 10° to about 90°, about 15° to about 60° or about 20° to about 40°, respectively.

The radial outer surface of the inner sleeve in particular relates to a surface of the inner sleeve facing the intermediate sleeve and/or the outer sleeve. The radial outer surface of the inner sleeve is therefore in particular arranged on a radial outer side of the inner sleeve.

In preferred embodiments of the bearing bush, the inwardly bent bend portions of the outer sleeve may be bent inwards after vulcanizing the elastomer body, in particular after vulcanizing the elastomer body to the inner sleeve and outer sleeve.

In other words, the two axial ends of the outer sleeve, that is, the two ends of the outer sleeve in the axial direction of the bearing bush, may not be radially inwardly bent until after arranging or forming the elastomer body for elastically connecting the inner sleeve and the outer sleeve. Accordingly, the outer sleeve may in particular have a substantially constant cross-section along the axial direction, in particular without inwardly bent bend portions, in an initial state before arranging or forming the elastomer body for elastically connecting the inner sleeve and the outer sleeve.

Thereby, the outer sleeve may advantageously be manufactured in an easy and cost-effective manner, in particular in a particularly efficient manner, for example by means of extrusion or continuous casting.

In further exemplary embodiments, after arranging or forming the elastomer body on the outer sleeve, in addition to bending at least one of the axial ends of the outer sleeve radially inwards, a reduction of the diameter of the outer sleeve may be made, in particular a reduction of the diameter of the outer sleeve which is substantially uniform along the axial direction and/or along the circumferential direction. The reduction of the diameter may in particular be performed even before bending the at least one axial end of the outer sleeve radially inwards.

Thereby, the inner diameter of the outer sleeve may advantageously be reduced, and a compressive stress may be applied on the elastomer body to counteract possible tensile stresses, for example due to a vibration of the elastomer body after vulcanizing, and to compensate or overcompensate tensile stresses possibly present in the elastomer body.

A second aspect of the disclosure relates to a bearing bush, in particular for a transverse control arm of a vehicle, having: an inner sleeve; an outer sleeve which is arranged radially around the inner sleeve; an elastomer body which is arranged between the inner sleeve and the outer sleeve and elastically connects them to each other; and an intermediate sleeve which is, at least in sections, embedded in the elastomer body; wherein a radial outer surface of the intermediate sleeve has a radially outwardly directed bulge along the axial direction of the bearing bush, and wherein a radial inner surface of the intermediate sleeve has a radially inwardly directed bulge along the axial direction of the bearing bush.

The bearing bush of the second aspect advantageously allows, by virtue of the intermediate sleeve, the kinematic properties and the damping properties of the bearing bush to be adjustable in a targeted manner by adjusting the radially outwardly directed bulge along the axial direction and by adjusting the radially inwardly directed bulge along the axial direction. In particular, the radial and/or axial stiffness may be adjusted to be high, while the cardanic stiffness and/or torsional stiffness may be kept low.

The above explanations regarding the bearing bush of the first aspect correspondingly applies to the bearing bush of the second aspect.

In particular, the outer sleeve of the bearing bush may adopt a maximum deflection or a maximum rotation in the torsional direction and/or maximum pivoting in the cardanic direction relative to the inner sleeve of the bearing bush in the range of about −35° to about +35°, for example in the range of about −25° to about +25°, or in the range of about −15° to about +15°, in particular without damaging the elastomer body.

In exemplary embodiments of the bearing bush, the intermediate sleeve may have a radially outwardly directed bulge substantially constant in the circumferential direction and/or a radially inwardly directed bulge substantially constant in the circumferential direction.

The radially outwardly directed bulge and/or the radially inwardly directed bulge may in particular be arranged or formed on the intermediate sleeve substantially centrally in the axial direction. The crowned or bulbous shape of the intermediate sleeve allows to keep the torsional stiffness and cardanic stiffness, which are parasitic for a transverse control arm, advantageously low.

A portion of the elastomer body arranged on the outer sleeve of the bearing bush of the second aspect may, in exemplary embodiments, have a radially protruding elastomeric stop portion, in particular a radially inwardly protruding inner stop portion which forms a radial stop with respect to a radial outer surface of the inner sleeve.

Unless explicitly stated otherwise, the statements below refer to the bearing bush based on both the first aspect and the second aspect.

In preferred embodiments of the bearing bush, the intermediate sleeve may be a plastic component, in particular a plastic component manufactured by means of injection molding, and/or may be an aluminum component, in particular an aluminum component manufactured by means of die casting, extrusion or continuous casting.

The intermediate sleeve may thus be a one-piece component, in particular manufactured from plastic, fiber-reinforced plastic or aluminum, or may be a multi-piece component which is manufactured from one or more of plastic, fiber-reinforced plastic and aluminum.

The formation of the intermediate sleeve with or from plastic, fiber-reinforced plastic and/or aluminum, as described above, advantageously secures a considerable freedom of shape in manufacturing the intermediate sleeve, while the intermediate sleeve is, at the same time, manufacturable in an application-specific and easy manner. Thereby, the bearing bush is advantageously manufacturable application-specifically in a particularly efficient manner. In particular, the intermediate sleeve may be provided with one or more radially outwardly directed and/or radially inwardly directed bulges and/or protrusions in a simple manner.

In exemplary embodiments, the intermediate sleeve may comprise or consist of polyamide, in particular comprise or consist of fiber-reinforced polyamide such as, for example, glass fiber-reinforced or carbon fiber-reinforced polyamide, and/or in particular comprise or consist of aluminum.

Furthermore, in preferred embodiments, the intermediate sleeve in particular may not comprise steel, particularly preferably may not comprise sheet steel. In conventional bearing bushes, it is frequently common to shape or bend an intermediate sleeve from sheet steel. Such an intermediate sleeve frequently has a substantially constant wall thickness. Although such an intermediate sleeve is easily manufacturable, it does not allow for application-specific design of the intermediate sleeve, in particular with regard to precisely adjustable bulges and/or protrusions. Moreover, conventional intermediate sleeves, which are produced from steel, in particular shaped from sheet steel, frequently cause piercing into the elastomer body with their axial ends upon vibrations of the bearing bush, whereby the service life of a bearing bush may be reduced. In contrast, the intermediate sleeve according to the disclosure, as described above, allows the stiffness properties and the damping properties of the bearing bush to be advantageously precisely adjustable, and in particular allows to constrain or prevent damage to the elastomer body which reduces the service life, while at the same time still securing a simple production of the intermediate sleeve and the bearing bush as a whole.

In particular, the present bearing bush allows the intermediate sleeve to be attachable in the inner sleeve in a single step and to be embeddable by the elastomer body.

While an intermediate sleeve made of sheet steel requires a step of explicitly inserting in relation to the inner sleeve and/or outer sleeve for overmolding and vulcanizing the elastomer body, the present intermediate sleeve may be picked up directly from production by means of injection molding or die casting in an automatable manner and positioned for a subsequent step of overmolding and vulcanizing the elastomer body. The present intermediate sleeve is, in other words, advantageously suitable for production as a partial step in a comparatively automated process for producing the bearing bush.

In exemplary embodiments, the intermediate sleeve may have rounded axial ends and, if applicable, rounded ends in the circumferential direction, in particular if the intermediate sleeve comprises multiple intermediate sleeve parts or intermediate sleeve shells spaced apart in the circumferential direction, whereby piercing of the elastomer body by the intermediate sleeve is advantageously reduced or prevented and furthermore the service life of the bearing bush is advantageously prolonged.

In further exemplary embodiments, the intermediate sleeve may in particular comprise or consist of metal, in particular a metal which has a larger density and is therefore heavier than aluminum, for example steel or cast iron. Accordingly, the intermediate sleeve may be manufactured in particular by means of casting or, for example, by means of sintering. An intermediate sleeve which is comparatively heavy in comparison with an intermediate sleeve made of plastic or aluminum allows to provide the bearing bush with improved high-frequency properties, wherein the intermediate sleeve acts as a vibration reducer, for example. For that purpose, the intermediate sleeve may also be configured as an iron or steel casting component and/or a sintered component.

In preferred embodiments of the bearing bush, the intermediate sleeve may be multi-part, that is, in particular comprise multiple intermediate sleeve segments or intermediate sleeve parts, wherein the intermediate sleeve comprises in particular two half-shells, wherein each half-shell has one outer stop portion, respectively, at the ends in the circumferential direction, that is, in particular the two ends in the circumferential direction.

The intermediate sleeve parts or intermediate sleeve segments of the intermediate sleeve may in particular be shaped so as to be adjacent to each other or touch each other in the circumferential direction and/or in the axial direction of the bearing bush. The intermediate sleeve parts or intermediate sleeve segments being adjacent to each other may in particular comprise a spacing in the circumferential direction in the range of about 0° to about 10°, preferably in the range of about 0° to about 5°, for example in the range of about 0° to about 2°.

In further exemplary embodiments, the intermediate sleeve parts or intermediate sleeve segments of the intermediate sleeve may be spaced apart from each other in the circumferential direction and/or in the axial direction of the bearing bush, for example be spaced apart from each other in the axial direction in a range of 1 mm to about 8 mm, and be spaced apart from each other in the circumferential direction in a range of about 3° to about 12°, preferably be spaced apart from each other in the circumferential direction in a range of about 5° to about 10°, in order for an elastomeric stop portion to extend into or through the spacing, for example.

Multi-part or multi-piece intermediate sleeves are advantageously easily manufacturable, wherein undercuts due to production in complex intermediate sleeve geometries of individual intermediate sleeves may advantageously be avoided.

In preferred embodiments of the bearing bush according to the second aspect and its preferred, exemplary and alternative embodiments, the elastomer body may protrude from a portion of the elastomer body facing the outer sleeve towards the inner sleeve or from a portion of the elastomer body facing the inner sleeve towards the outer sleeve in a region where the intermediate sleeve segments or intermediate sleeve parts of the intermediate sleeve are spaced apart from each other in the circumferential direction. The respectively protruding portion of the elastomer body may form an elastomeric stop portion and may in particular protrude so as to extend, at least in sections, in the spacing or completely through the spacing of the intermediate sleeve segments or intermediate sleeve parts, that is, in particular radially thereinto or therethrough.

The protruding elastomeric stop portion of the elastomer body may thereby in particular form a radial stop towards the respective inner sleeve or outer sleeve towards which it extends.

In preferred embodiments, the elastomeric stop portions of the elastomer body may be arranged diametrically opposite with respect to the circumferential direction, which advantageously allows the damping properties of the bearing bush to be adjustable, in particular in the direction of the diametrically opposite elastomeric stop portions, in particular as compared to elastomeric stop portions uniformly arranged in the circumferential direction.

In exemplary embodiments, the at least two radially inwardly or outwardly protruding elastomeric stop portions of the elastomer body may in particular be oriented along the traveling direction, that is, the frontward-rearward direction of the vehicle, and be opposed to each other. The orientation of the at least two radially inwardly or outwardly protruding elastomeric stop portions along the traveling direction may in particular be such that the traveling direction intersects the at least two radially inwardly or outwardly protruding elastomeric stop portions, or the two radially inwardly or outwardly protruding elastomeric stop portions are adjacent to the traveling direction, in particular adjacent to the traveling direction in a range of about 0° to about 5°.

The at least two radially inwardly or outwardly protruding elastomeric stop portions which are arranged diametrically opposite one another may be formed over an angular range of about 10° to about 90°, about 15° to about 60° or about 20° to about 40°, respectively.

In exemplary embodiments of the bearing bush, the radially outwardly protruding elastomeric stop portion of the elastomer body thus may form a radial stop with respect to a radial inner surface of the outer sleeve.

In further exemplary embodiments of the bearing bush, the radially inwardly protruding elastomeric stop portion of the elastomer body thus may form a radial stop with respect to a radial outer surface of the inner sleeve.

In the region of the elastomeric stop portion, a comparatively thin elastomer layer may be provided. In this case, the elastomer layer which may be formed contiguously with the elastomer body may have a thickness in the range of about 0.2 mm to about 2 mm in the region of a respective stop.

A third aspect of the disclosure relates to a method for manufacturing a bearing bush, in particular a bearing bush based on the first aspect, in particular for a transverse control arm of a vehicle, wherein the method comprises the steps of: providing an inner sleeve; providing an outer sleeve which has a larger radius than the inner sleeve; providing an intermediate sleeve for arrangement between the inner sleeve and the outer sleeve, wherein a radial outer surface of the intermediate sleeve has a radially outwardly directed bulge along the axial direction of the bearing bush, and wherein the intermediate sleeve has a radially outwardly protruding outer stop portion, forming an elastomer body, in particular overmolding and vulcanizing an elastomer body, between the inner sleeve and the outer sleeve such that the elastomer body elastically connects the inner sleeve and the outer sleeve to each other and the intermediate sleeve is, at least in sections, embedded in the elastomer body; bending axial ends of the outer sleeve radially inwards to form a bend portion at each axial ends of the outer sleeve, that is, in particular at each of the two axial ends of the outer sleeve, wherein the outer stop portion forms an axial stop with respect to or opposing an axial inner surface of the bend portion of the outer sleeve.

In other words, the step of bending axial ends of the outer sleeve radially inwards to form a bend portion at each of the axial ends of the outer sleeve, that is, in particular at each of the two axial ends of the outer sleeve, may in particular be executed such that the outer stop portion forms an axial stop with respect to an axial inner surface of the bend portion of the outer sleeve.

By virtue of the method according to the third aspect, a bearing bush is advantageously adjustable with targeted kinematic properties and damping properties, wherein the bearing bush is in particular suitable as a bearing bush of a transverse control arm of a vehicle, such as, for example, as a radius arm bearing bush.

Preferred, exemplary and alternative embodiments of the bearing bush based on the first aspect as well as their effects equally relate to the method for manufacturing a bearing bush based on the third aspect and vice versa.

In exemplary embodiments, the intermediate sleeve may be provided separately from the inner sleeve or may be provided integrally with the inner sleeve. The intermediate sleeve and the inner sleeve may thus be provided separately from each other or may be provided together, that is, in one piece.

In preferred embodiments of the method for manufacturing a bearing bush, the steps of forming an elastomer body, and bending axial ends of the outer sleeve radially inwards, or all steps of the method for manufacturing a bearing bush are executed in this order or in the order specified above.

A fourth aspect of the present disclosure relates to a method for manufacturing a bearing bush, in particular a bearing bush based on the second aspect, in particular for a transverse control arm of a vehicle, wherein the method comprises the steps of: providing an inner sleeve; providing an outer sleeve which has a larger radius than the inner sleeve; providing an intermediate sleeve for arrangement between the inner sleeve and the outer sleeve, wherein a radial outer surface of the intermediate sleeve has a radially outwardly directed bulge along the axial direction of the bearing bush, and wherein a radial inner surface of the intermediate sleeve has a radially inwardly directed bulge along the axial direction of the bearing bush, forming an elastomer body, in particular overmolding and vulcanizing an elastomer body, between the inner sleeve and the outer sleeve such that the elastomer body elastically connects the inner sleeve and the outer sleeve to each other and the intermediate sleeve is, at least in sections, embedded in the elastomer body.

By virtue of the method according to the fourth aspect, a bearing bush is advantageously adjustable with targeted kinematic properties and damping properties, wherein the bearing bush is in particular suitable as a bearing bush of a transverse control arm of a vehicle.

Preferred, exemplary and alternative embodiments of the bearing bush based on the second aspect as well as their effects equally relate to the method for manufacturing a bearing bush based on the fourth aspect and vice versa.

In preferred embodiments of the method for manufacturing a bearing bush based on the fourth aspect, in particular the following steps may be included: bending axial ends of the outer sleeve radially inwards to form a bend portion at each axial ends of the outer sleeve, that is, in particular at each of the two axial ends of the outer sleeve.

In further preferred embodiments, the step of bending axial ends of the outer sleeve radially inwards may be performed after the step of forming an elastomer body, with the effects as emphasized in particular with regard to the above aspects.

In exemplary embodiments of the method for manufacturing a bearing bush based on the third or fourth aspect, the method may comprise a step of reducing the diameter of the outer sleeve.

This also advantageously allows to apply compressive stresses to the elastomer body, in particular the elastomer body attached to the outer sleeve.

In preferred embodiments of the method for manufacturing a bearing bush based on the third or fourth aspect, the method may comprise at least one of the following steps: extruding, die-casting or continuously casting the inner sleeve; extruding or continuously casting the outer sleeve; and injection-molding or die-casting the intermediate sleeve.

In exemplary embodiments, when the inner sleeve and the intermediate sleeve are formed together or in one piece, the inner sleeve and the intermediate sleeve may, exemplarily, be manufactured by means of die casting, that is, in one piece by means of die casting. A corresponding method may comprise a step of die-casting the inner sleeve in one piece with the intermediate sleeve.

The steps of extruding or continuously casting the inner sleeve and/or the outer sleeve allow to form the inner sleeve and/or the outer sleeve advantageously efficiently and in particular with a substantially constant cross-section. The inner sleeve and/or the outer sleeve may in particular comprise or consist of steel, aluminum or an alloy having at least one of the two in extrusion or continuous casting. While steel supports an advantageously stable formation of the inner sleeve and/or the outer sleeve, aluminum advantageously allows to form the inner sleeve and/or the outer sleeve to be particularly light-weighted, that is, weight-saving, and to reduce the risk of corrosion on the bearing bush.

The step of die-casting the inner sleeve advantageously allows to form the inner sleeve to be contoured and, for example, integrally with the intermediate sleeve. The inner sleeve may in particular comprise or consist of aluminum, zinc, magnesium, copper or an alloy having at least one of these in die casting, if applicable integrally with the intermediate sleeve. The mentioned die casting materials, together with the die casting, advantageously allow to form the inner sleeve and, if applicable, also the intermediate sleeve integrally with the inner sleeve, advantageously light-weighted, that is, weight-saving, while the inner sleeve and, if applicable, additionally the intermediate sleeve, may have any contoured shape by providing the cavity for die casting with a predetermined geometry.

The step of injection-molding the intermediate sleeve advantageously allows to form the intermediate sleeve to be contoured and in particular with or from plastic. Thereby, the intermediate sleeve may advantageously be formed cost-effectively, with a predetermined geometry, and moreover, depending on the plastic used, to be insulating. The injection molding of the intermediate sleeve accordingly advantageously allows to provide the intermediate sleeve with precisely adjustable stiffness properties and corrosion properties.

This is advantageous in particular in the case of bearing bushes of transverse control arms, since those are subject to a plurality of load cases depending on the road, speed, braking, acceleration and steering behavior, and moreover, are significantly subject to the environment, that is, in particular dirt and water.

### BRIEF DESCRIPTION OF DRAWINGS

FIG. 1a shows a portion of a chassis, comprising a bearing bush according to an embodiment of the present disclosure;

FIG. 1b shows a transverse control arm comprising a bearing bush according to an embodiment of the present disclosure;

FIG. 2a shows a perspective view of a bearing bush according to an embodiment of the present disclosure in a partially sectioned illustration;

FIG. 2b shows an exploded view of the bearing bush according to FIG. 2a;

FIG. 3a shows a first sectional view of the bearing bush according to FIG. 2a;

FIG. 3b shows a second sectional view of the bearing bush according to FIG. 2a;

FIG. 4a shows a perspective view of another bearing bush according to an embodiment of the present disclosure in a partially sectioned illustration;

FIG. 4b shows an exploded view of the bearing bush according to FIG. 4a;

FIG. 5a shows a first sectional view of the bearing bush according to FIG. 4a;

FIG. 5b shows a second sectional view of the bearing bush according to FIG. 4a;

FIG. 6a shows a perspective view of another bearing bush according to an embodiment of the present disclosure in a partially sectioned illustration;

FIG. 6b shows an exploded view of the bearing bush according to FIG. 6a;

FIG. 7a shows a first sectional view of the bearing bush according to FIG. 6a;

FIG. 7b shows a second sectional view of the bearing bush according to FIG. 6a;

FIG. 8a shows a perspective view of another bearing bush according to an embodiment of the present disclosure in a partially sectioned illustration;

FIG. 8b shows an exploded view of the bearing bush according to FIG. 8a;

FIG. 9a shows a first sectional view of the bearing bush according to FIG. 8a;

FIG. 9b shows a second sectional view of the bearing bush according to FIG. 8a;

FIG. 10 shows a flowchart of a method for manufacturing a bearing bush according to an embodiment of the present disclosure; and

FIG. 11 shows a flowchart of a method for manufacturing a bearing bush according to an embodiment of the present disclosure.

### DETAILED DESCRIPTION OF PREFERRED EMBODIMENTS

Hereinafter, embodiments of the disclosure are described in more detail on the basis of the appended figures. It is to be understood that the present disclosure is not limited to these embodiments and that individual features of the embodiments may be combined to create further embodiments within the scope of the appended claims.

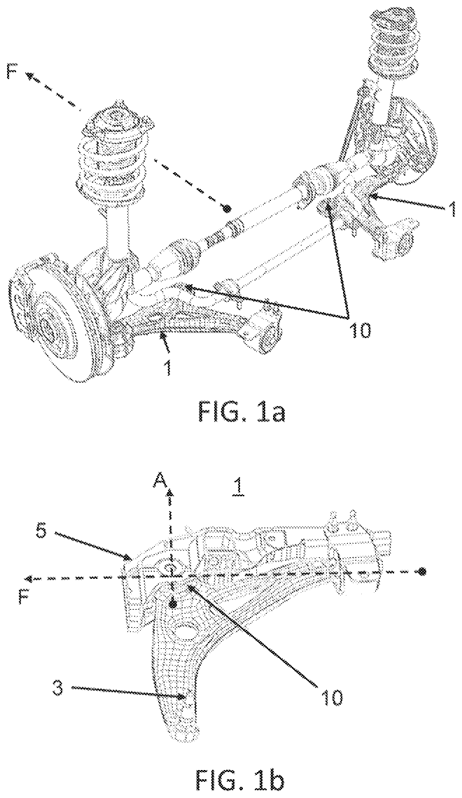

FIG. 1a shows a portion of a chassis of a vehicle, in particular of a front axle portion of a vehicle, wherein the portion of the chassis illustrated comprises a left-side transverse control arm 1 and a right-side transverse control arm 1 which are coupled to the left or right wheel suspension, respectively. The wheels to be suspended therewith are not illustrated for the sake of clarity.

In FIG. 1a, a traveling direction F is exemplarily shown as a traveling direction forwardly directed for a vehicle. The forwardly directed traveling direction F is in particular parallel to the front-rear direction of the relevant vehicle.

As shown in FIGS. 1a and 1b, the respective transverse control arms 1 each comprise a bearing bush 10 according to an embodiment of the present disclosure. The bearing bush 10 is fixed, in particular press-fitted, to the transverse control arm 1 with its outer sleeve 40 and may be fixed in particular to a vehicle body portion 5 with its inner sleeve 20, as illustrated in FIG. 1b.

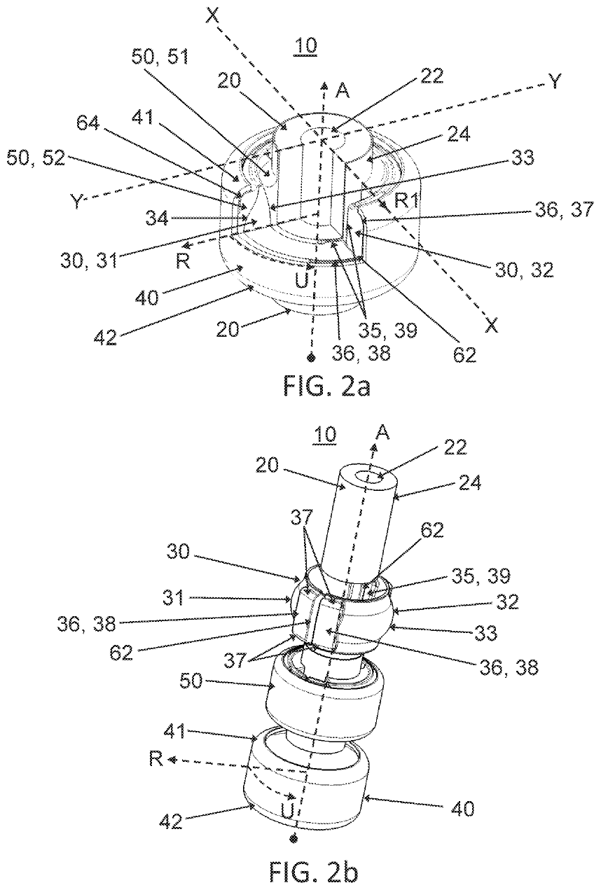

The journal exemplarily illustrated on the transverse control arm 1 forms a wheel carrier link 3 which is connectable to the wheel carrier, wherein the wheel carrier is, respectively, in particular configured to receive a respective wheel. The wheel carrier link 3 may in particular be fixed to the transverse control arm 1 by means of a ball joint. In addition to the bearing bush 10, as shown in FIG. 1b, the transverse control arm 1 may have one or more further bushes for indirect connection to another or the same vehicle body portion 5. The section in an X-X direction, as shown in FIGS. 2a to 9b, corresponds in particular to a section in a first predetermined radial direction R1 which in turn, in the mounted state of the bearing bush 10, may be substantially parallel to the traveling direction F, as shown in FIGS. 1a and 1b. Accordingly, the X-X direction or the first predetermined radial direction R1, as shown in the relevant figures, in particular represents a direction which is substantially parallel to the traveling direction F, as shown in Figure Tb.

FIG. 2a shows a perspective view of a bearing bush 10 according to an embodiment of the present disclosure in a partially sectioned illustration.

The bearing bush 10, as shown in FIG. 2a, comprises an inner sleeve 20, an outer sleeve 40 which is arranged radially around the inner sleeve 20, and an elastomer body 50 which elastically connects the inner sleeve 20 to the outer sleeve 40. The bearing bush 10 further comprises an intermediate sleeve 30 which is arranged between the inner sleeve 20 and the outer sleeve 40, in particular arranged radially between the inner sleeve 20 and the outer sleeve 40. The intermediate sleeve 30 is, at least in sections, embedded in the elastomer body 50 and, in exemplary embodiments, may be completely embedded in the elastomer body 50, that is, embedded in the elastomer body 50 so as to be completely surrounded by the elastomer body 50.

The bearing bush 10 shown in FIG. 2a is partially sectioned along a radial X-X direction and partially sectioned along a radial Y-Y direction. The X-X direction is substantially perpendicular to the Y-Y direction or, in other words, is offset from the Y-Y direction by approximately 90° in the circumferential direction. The X-X direction and the Y-Y direction running substantially perpendicular thereto are intended to illustrate the formation of the bearing bush 10 in terms of the various spatial directions, in particular along the circumferential direction U. Both the X-X direction and the Y-Y direction each illustrate a section with a sectional plane which spans substantially by the axial direction A and the radial direction R.

Furthermore, in FIG. 2a, the bearing bush 10 is illustrated as partially sectioned in a plane which spans substantially in the circumferential direction U and in the radial direction R, whereby an exemplary change in the wall thickness or thickness of the intermediate sleeve 30 in the radial direction R along the circumferential direction U is illustrated.

As shown in FIG. 2a, the inner sleeve 20 may in particular have a substantially constant cross-section, that is, in particular an inner circumferential surface 22 having a substantially constant diameter, and an outer circumferential surface 24 having a substantially constant diameter, wherein the inner circumferential surface 22 is arranged on a radially inner side of the inner sleeve 20, and the outer circumferential surface 24 is arranged on a radially outer side of the inner sleeve 20. Thereby, the inner sleeve 20 may advantageously be manufactured in a simple manner, for example by means of continuous casting or extrusion.

In embodiments alternative thereto, at least one of the inner circumferential surface 22 and the outer circumferential surface 24 may have a contour that differs from a constant diameter.

Furthermore, in the installed state, that is, in particular in a state arranged on a transverse control arm 1, the inner sleeve 20 may be different from the original formation with a constant cross-section and have multiple flanges, chamfers, threads, sealing grooves or the like.

As shown in FIG. 2a, the bearing bush 10 and at least one of the inner sleeve 20, the intermediate sleeve 30 and the outer sleeve 40 has a cylinder-shaped extension along an axial direction A. The axial direction A may in particular form an axis of symmetry, in terms of rotational symmetry, for the inner sleeve 20. The inner sleeve 20 and the outer sleeve 40 may in particular be arranged substantially concentrically to each other. Furthermore, in exemplary embodiments, the intermediate sleeve 30 may be arranged substantially concentrically to the inner sleeve 20 and/or to the outer sleeve 40.

As shown in FIG. 2a, the outer sleeve 40 may have a first bend portion 41 at a first axial end and may have a second bend portion 42 at a second axial end which, in particular, is arranged opposite the first axial end in the axial direction A. In other words, in preferred embodiments, the outer sleeve 40 may have at least one of a first bend portion 41 and a second bend portion 42 at which the outer sleeve 40 is radially inwardly bent.

As illustrated in FIG. 2a, the bend portions 41, 42 of the outer sleeve 40 may be bent so as to be inclined with respect to the axial direction A, or so as to substantially face towards the axial direction A in the radial direction R. In other words, the bend portions 41, 42 may be bent or shaped to face the axial direction A or substantially perpendicular towards the axial direction A with a respective axial outermost end of the outer sleeve 40 inclined.

By bending the bend portions 41, 42 to such a large extent, on the one hand, a high compressive stress may advantageously be applied to the elastomer body 50 and, on the other hand, the axial stop 37 may advantageously be precisely adjusted between the outer sleeve 40 and the intermediate sleeve 30, whereby furthermore the kinematic properties and the damping properties of the bearing bush 10 are precisely adjustable. On the other hand, by bending the bend portions 41, 42 to such a large extent, advantageously both the radial and the axial stiffness of the bearing bush may be increased without increasing the parasitic stiffnesses, that is, without increasing the cardanic stiffness and the torsional stiffness. By means of the axial stop 37, a limitation may advantageously be provided, so that a predetermined path region in one or more force-path characteristic curve(s) of the bearing bush 10 is adjusted within which the bearing bush 10 may move or be deflected.

The bend portions 41, 42 may have an extension, in particular an axial extension along the axial direction A, starting from an axial end of the outer sleeve 40, in the range of about 2 mm to about 6 mm in the bent state.

In exemplary embodiments, the outer sleeve 40 may have a substantially axial extension before having the bend portions 41, 42, in particular with a cross-section substantially constant in the axial direction A, that is, in particular with a substantially constant inner diameter and outer diameter. Thereby, the outer sleeve 40 may advantageously be manufactured in a simple manner, for example by means of extrusion or continuous casting.

The intermediate sleeve 30 may be a part which is continuous in the circumferential direction and, in other words, radially surrounds the inner sleeve 20 by 360°, or may be formed in multiple pieces and thereby comprises multiple intermediate sleeve parts 31, 32 which may in particular be formed as half-shells.

In exemplary embodiments, and as exemplarily indicated in FIG. 2a, the intermediate sleeve 30 may comprise at least a first intermediate sleeve part 31 and a second intermediate sleeve part 32. The intermediate sleeve parts and, in particular, the first intermediate sleeve part 31 and the second intermediate sleeve part 32, may preferably be adjacent to each other in the circumferential direction U and may, for example, be separated or spaced apart from each other by a spacing 62 in the circumferential direction.

In alternative embodiments, the spacing 62 may form, in other spatial directions, a separation between multiple intermediate sleeve parts of the intermediate sleeve 30, for example in the axial direction A.

In the circumferential direction U, the spacing 62 may in particular form a separation between intermediate sleeve parts 31, 32 adjacent to each other in the range of about 0° to about 45°.

As exemplified in FIG. 2a, the intermediate sleeve 30 and accordingly, if applicable, at least one of the first intermediate sleeve part 31 and the second intermediate sleeve part 32 may have a radially inwardly directed bulge 33, in particular on a radial inner surface. The radially inwardly directed bulge 33 may, in other words, in particular be arranged or formed on a radial inner side or an inner circumferential side of the intermediate sleeve 30, that is, on a side of the intermediate sleeve 30 facing the inner sleeve 20 in the radial direction R. The radially inwardly directed bulge 33 of the intermediate sleeve 30 may in particular be defined by a predetermined axial extension along the axial direction A, by a predetermined curvature along the axial direction A, and by a predetermined maximum extension towards the inner sleeve 20, that is, by the smallest radially inwardly directed diameter of the intermediate sleeve 30, whereby the stiffness of the intermediate sleeve 30, and thereby furthermore the damping properties of the bearing bush 10, are advantageously precisely adjustable.

In further alternative embodiments, the intermediate sleeve 30 may have a substantially constant inner diameter or an inner diameter substantially constant at least in sections, wherein the inner diameter substantially constant in some sections may transition into the radially inwardly directed bulge 33 or the radially outwardly directed recess or vice versa following the axial direction A, according to the axial extension of the radially inwardly directed bulge 33 or the radially outwardly directed recess. In other words, in exemplary embodiments, the intermediate sleeve 30 may have a substantially constant inner diameter in some sections and, adjacent thereto in some sections, at least one of the radially inwardly directed bulge 33 or the radially outwardly directed recess along the axial direction A.

As exemplified in FIG. 2a, the intermediate sleeve 30 and accordingly, if applicable, at least one of the first intermediate sleeve part 31 and the second intermediate sleeve part 32, may have a radially outwardly directed bulge 34, in particular on a radial outer surface. The radially outwardly directed bulge 34 may, in other words, in particular be arranged or formed on a radial outer side or an outer circumferential side of the intermediate sleeve 30, that is, on a side of the intermediate sleeve 30 facing the outer sleeve 40 in the radial direction R. The radially outwardly directed bulge 34 of the intermediate sleeve 30 may in particular be defined by a predetermined axial extension along the axial direction A, by a predetermined curvature along the axial direction A, and by a predetermined maximum extension towards the outer sleeve 40, that is, by the largest radially outwardly directed outer diameter of the intermediate sleeve 30, aside from possible protrusions, whereby the stiffness of the intermediate sleeve 30, and thereby furthermore the damping properties of the bearing bush 10, are advantageously precisely adjustable.

As further exemplified in FIG. 2a, the intermediate sleeve 30 and accordingly, if applicable, at least one of the first intermediate sleeve part 31 and the second intermediate sleeve part 32, may have a radially outwardly protruding outer stop portion 36, in particular on a radial outer side. The radially outwardly protruding outer stop portion 36 may, in other words, in particular be arranged or formed on a side of the intermediate sleeve 30 facing the outer sleeve 40 in the radial direction R. The radially outwardly protruding outer stop portion 36 of the intermediate sleeve 30 may protrude further radially than the outwardly directed bulge 34 of the intermediate sleeve 30.

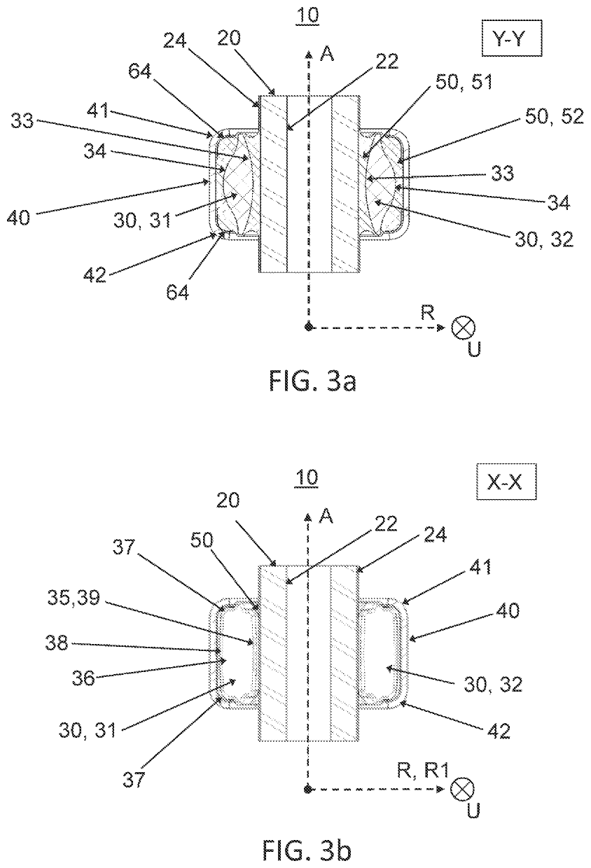

As shown in FIG. 2a and further illustrated by FIG. 3b, the radially outwardly protruding outer stop portion 36 of the intermediate sleeve 30 forms an undercut relative to the outer sleeve 40, in particular relative to the at least one bend portion 41, 42 of the outer sleeve 40, in the axial direction A.

If the intermediate sleeve 30 is deflected by a predetermined amount in the axial direction A when damping a load which acts on the bearing bush 10, the radially outwardly protruding outer stop portion 36 strikes in particular against an axial inner surface of one of the bend portions 41, 42, that is, in particular against an inner circumferential side of the outer sleeve 40 which faces the outer stop portion 36 in the axial direction A. The outer stop portion 36 of the intermediate sleeve 30 therefore in particular forms an axial stop 37 relative to the outer sleeve 40, and thereby a kinematic limitation for the bearing bush 10 which is adjustable in a simple manner. Furthermore, pull-out of the intermediate sleeve 30 and/or the inner sleeve 20 from the outer sleeve 40 is counteracted.

While the deflection of the intermediate sleeve 30 until striking the outer sleeve 40 is determined substantially by the damping properties based on the elastomer body 50 in cooperation with the intermediate sleeve 30 embedded therein, the damping properties from striking of the intermediate sleeve 30 against the outer sleeve 40 is additionally determined by the contact between the intermediate sleeve 30 and the outer sleeve 40, wherein the intermediate sleeve 30 generally constitutes a stiffer body than the elastomer body 50. Thereby, the axial deflection of the intermediate sleeve 30, and thus the tensile stress applied to the elastomer body 50, may advantageously be limited when damping a load, so that further advantageously the service life of the bearing bush 10 may be improved.

As further shown in FIG. 2a and illustrated in FIG. 3b, in exemplary embodiments, the outer stop portion 36 may form an outer radial stop 38 with respect to or opposing the outer sleeve 40, in particular with respect to a radial inner surface of the outer sleeve 40, that is, in particular with respect to an inner circumferential side of the outer sleeve 40 radially facing the outer stop portion 36.

Similar to the axial stop 37, the outer radial stop 38 allows to advantageously limit the radial deflection of the intermediate sleeve 30, and thus the tensile stress applied to the elastomer body 50, when damping a load, so that further advantageously the service life of the bearing bush 10 may be improved.

As further exemplified in FIG. 2a, the intermediate sleeve 30 may in particular have a radially inwardly protruding inner stop portion 35 which forms an inner radial stop 39 with respect to a radial outer surface of the inner sleeve 20 or with respect to the outer circumferential surface 24 of the inner sleeve 20. The radially inwardly protruding inner stop portion 35 of the intermediate sleeve 30 is preferably arranged or formed within a region limited in the circumferential direction U. The radially inwardly protruding inner stop portion 35 of the intermediate sleeve 30 in particular protrudes further radially inwards than the radially inwardly directed bulge 33.

Similar to the axial stop 37 and the outer radial stop 38, the inner radial stop 39 allows to advantageously limit the radial deflection of the intermediate sleeve 30, and thus the tensile stress applied to the elastomer body 50, when damping a load, so that further advantageously the service life of the bearing bush 10 may be improved.

FIG. 2b shows an exploded view of the bearing bush 10 according to FIG. 2a.

As illustrated exemplarily in FIG. 2b, the intermediate sleeve 30 may in particular be formed in multiple parts or in multiple pieces, for example by a first intermediate sleeve part 31 and a second intermediate sleeve part 32, wherein each intermediate sleeve part 31, 32 radially surrounds the inner sleeve 20 along a portion in the circumferential direction U. In further exemplary embodiments, the intermediate sleeve 30 may in particular be formed in one piece or in one part. In still further exemplary embodiments, the intermediate sleeve 30 may be formed by more than two intermediate sleeve parts 31, 32, for example by three, four, five, six or more intermediate sleeve parts. The intermediate sleeve parts 31, 32 may preferably have a spacing 62 from each other substantially in the circumferential direction U, that is, from the respectively adjacent intermediate sleeve part.

As shown in FIG. 2b, the intermediate sleeve 30 may have multiple outer stop portions 36 which may preferably be formed adjacent to each other in the circumferential direction U. This advantageously allows to provide the intermediate sleeve 30 with stiffness properties and kinematic properties specific to the circumferential direction U at targeted locations, and in particular in the first predetermined radial direction R1.

As shown by FIGS. 2a, 2b and 3b, the outer stop portion 36 or the outer stop portions 36 of the intermediate sleeve 30 may be oriented substantially along the first predetermined radial direction in the circumferential direction U, as exemplarily illustrated by the X-X direction in FIGS. 2a and 3b.

In preferred embodiments, and as illustrated by the sectional view in FIG. 3b, the intermediate sleeve 30 may have multiple outer stop portions 36 which are arranged or formed diametrically opposite one another on the intermediate sleeve 30.

FIG. 3a shows a first sectional view of the bearing bush 10 according to FIG. 2a along the Y-Y direction, that is, in a plane substantially perpendicular to the first predetermined radial direction R1, or in a plane which is substantially spanned by the Y-Y direction, as shown in FIG. 2a, and the axial direction A.

As shown in FIG. 3a, the intermediate sleeve 30 may in particular have a radially inwardly directed bulge 33, wherein the intermediate sleeve 30 has an increasing inner diameter on a side facing the inner sleeve 20, towards the axial ends of the intermediate sleeve 30. At a central position of the intermediate sleeve 30 in the axial direction A, the intermediate sleeve 30, in exemplary embodiments, may accordingly have a smallest inner diameter.

As further shown in FIG. 3a, the intermediate sleeve 30 has in particular a radially outwardly directed bulge 34, wherein the intermediate sleeve 30 has an increasing outer diameter on a side facing the outer sleeve 40, towards an axial center of the intermediate sleeve 30, so that the intermediate sleeve 30 assumes a crowned shape. At a central position of the intermediate sleeve 30 in the axial direction A, the intermediate sleeve 30, in exemplary embodiments, may accordingly have a largest outer diameter.

As further shown in FIG. 3a, the bearing bush 10 may have a gap or slit 64 between the outer sleeve 40 and the elastomer body 50 in the region of the bend portions 41, 42 of the outer sleeve 40. The gap 64 may be arranged to be continuous in the circumferential direction U or distributed in the circumferential direction U. The gap 64 may be generated by the geometry of the elastomer body 50 when bending the bending portions 41, 42. The gap 64 may, however, also be provided by applying a release agent at the axial ends of the inner circumferential side of the outer sleeve 40 before overmolding and vulcanizing the elastomer body 50, for example, or may be introduced subsequently by means of post-processing. By virtue of the gap 64, the cardanic stiffness of the bearing bush 10 is advantageously reduced while a radial stiffness may substantially be maintained.

As further shown in FIG. 3a, the elastomer body 50 may in particular have a first elastomer layer 51 facing the inner sleeve 20 and a second elastomer layer 52 facing the outer sleeve 40, wherein the first elastomer layer 51 is, at least in sections, separated from the second elastomer layer 52 by the intermediate sleeve 30.

The first elastomer layer 51 and/or the second elastomer layer 52 may have a varying wall thickness or thickness along the axial direction A, in particular depending on the contour of the intermediate sleeve 30 and the contours of the inner circumferential side of the outer sleeve 40 and the outer circumferential side of the inner sleeve 20. The thinner the wall thickness or thickness of the respective elastomer layer 51, 52, the stiffer or more rigid the elastomer body 50 is at the respective location.

In exemplary embodiments, as shown in particular by FIGS. 2a to 3b, the first elastomer layer 51 may have a wall thickness of about 2 mm to about 4 mm, preferably of about 2 mm to about 3 mm, in particular at a central position in the axial direction A, in particular in a region of the intermediate sleeve 30 where no inner stop portion 35 is arranged or formed.

In further exemplary embodiments, as shown in particular by FIGS. 2a to 3b, the second elastomer layer 52 may have a wall thickness of about 1.5 mm to about 12 mm, preferably of about 4 mm to about 10 mm, in particular at a central position in the axial direction A, in particular in a region of the intermediate sleeve 30 where no outer stop portion 36 is arranged or formed. It is to be understood that correspondingly larger or smaller-scaled bearing bushes 10 may have correspondingly larger or smaller wall thicknesses, in particular with regard to the first elastomer layer 51 and/or the second elastomer layer 52.

While the first elastomer layer 51, which is comparatively thin in comparison with the second elastomer layer 52, allows for a comparatively stiff link of the intermediate sleeve 30 to the inner sleeve 20, the comparatively thick second elastomer layer 52 secures a low cardanic stiffness and a low torsional stiffness, while at the same time a maximum deflection of the intermediate sleeve 30, and thus of the elastomer body 50, as illustrated by FIG. 3b, is advantageously limited by the inner stop portion 35 and/or the outer stop portion 36.

As shown by FIGS. 2a and 3a, the first elastomer layer 51 and the second elastomer layer 52 of the elastomer body 50 may in particular be connected to each other at axial ends of the intermediate sleeve 30.

FIG. 3b shows a second sectional view of the bearing bush 10 according to FIG. 2a, along the X-X direction or along the first predetermined radial direction R1, that is, in a plane which is substantially spanned by the X-X direction, as shown in FIG. 2a, and the axial direction A.

As shown in FIG. 3b, the intermediate sleeve 30 may have multiple outer stop portions 36 (in FIG. 3b, illustrated only on the left with reference numeral for the sake of clarity, but present on the right as well) which are arranged or formed diametrically opposite one another on the intermediate sleeve 30.

The outer stop portions 36 each form an axial stop 37 with respect to the axial inner surfaces of the bend portions 41, 42 in the axial direction A, so that the deflection of the intermediate sleeve 30 in the axial direction A relative to the outer sleeve 40, and thereby accordingly the deformation of the elastomer body 50, is advantageously limited.

The outer stop portions 36 may further each form an outer radial stop 38 with respect to the radial inner surfaces of the outer sleeve 40 in the radial direction R, so that the deflection of the intermediate sleeve 30 in the radial direction R, relative to the outer sleeve 40, and thereby accordingly the deformation of the elastomer body 50, is advantageously limited.

As further shown in FIG. 3b, the intermediate sleeve 30 may have multiple inner stop portions 35 (in FIG. 3b, illustrated only on the left with reference numeral for the sake of clarity, but present on the right as well) which are arranged or formed diametrically opposite one another on the intermediate sleeve 30. The inner stop portions 35 may each form an inner radial stop 39 with respect to the radial outer surfaces of the inner sleeve 20 in the radial direction R, so that the deflection of the intermediate sleeve 30 in the radial direction R, relative to the inner sleeve 20, and thereby accordingly the deformation of the elastomer body 50, is advantageously limited.

In preferred embodiments of a transverse control arm 1, which comprises a bearing bush 10 according to one of FIGS. 2a, 2b, 3a and 3b, the outer stop portion 36 and/or the inner stop portion 35 or the respective plurality thereof may be oriented substantially in parallel to or along the first predetermined radial direction R1.

The orientation of the one or more outer stop portions 36 and/or of the one or more inner stop portions 35 along the first predetermined radial direction R1 may in particular be such that the first predetermined radial direction R1 intersects the outer stop portion(s) 36 and/or the inner stop portion(s) 35, or the outer stop portion(s) 36 and/or the inner stop portion(s) 35 are adjacent to the first predetermined radial direction R1, in particular in a range of about 0° to about 15° in the circumferential direction.

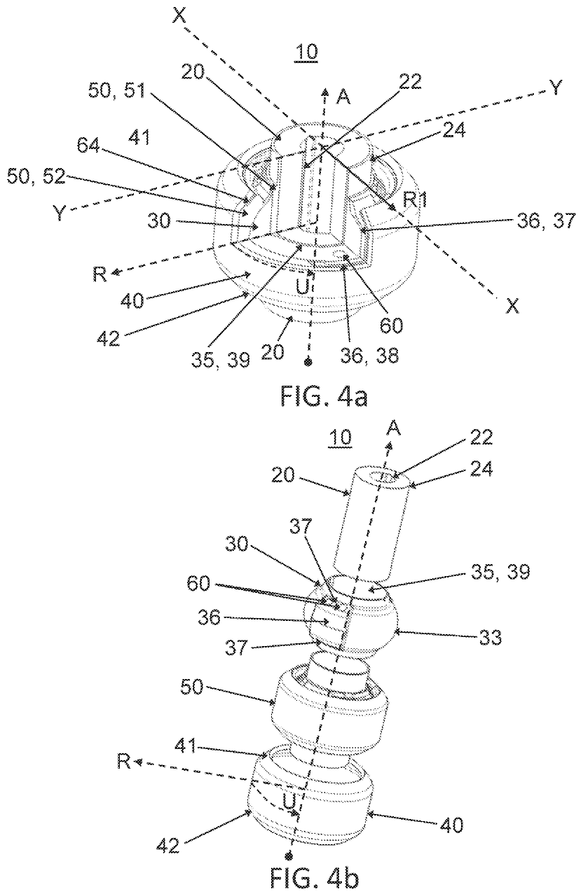

The above features and effects regarding the embodiments, as explained on the basis of FIGS. 2a to 3b, analogously relate to the embodiments, as shown in FIGS. 4a to 9b, unless otherwise specified.

In particular, the above explanations concerning the bend portions 41, 42, in particular also in the context of the intermediate sleeve 30 and/or the outer stop portions 36, concerning the inner sleeve 20, concerning the outer sleeve 40, concerning the spacing 62 in the circumferential direction U between the intermediate sleeve parts 31, 32, concerning the gap 64 between the outer sleeve 40 and the elastomer body 50, concerning the first elastomer layer 51 and the second elastomer layer 52, concerning the inner stop portion(s) 35 and/or the outer stop portion(s) 36, concerning the behavior upon striking, further concerning the illustration based on sections, in particular in the Y-Y direction and in the X-X direction, as in particular corresponding to the first predetermined radial direction R1, as explained on the basis of FIGS. 2a to 3b, unless otherwise specified, analogously apply to the respective embodiments, as shown in FIGS. 4a to 5b, 6a to 7b, and 8a to 9b. Accordingly, regarding the embodiments shown in FIGS. 4a to 5b, 6a to 7b, and 8a to 9b, substantially the differences from the embodiments of FIGS. 2a to 3b are described in the following.

FIG. 4a shows a perspective view of another bearing bush 10 according to an embodiment of the present disclosure in a partially sectioned illustration.

As compared to the bearing bush 10 according to FIG. 2a, the bearing bush 10 according to FIG. 4a comprises in particular an intermediate sleeve 30 which, in the circumferential direction, is a continuous part which, in other words, thus radially surrounds the inner sleeve 20 by 360°. In further other words, the intermediate sleeve 30 according to FIG. 4a is in particular formed in one piece or in one part.

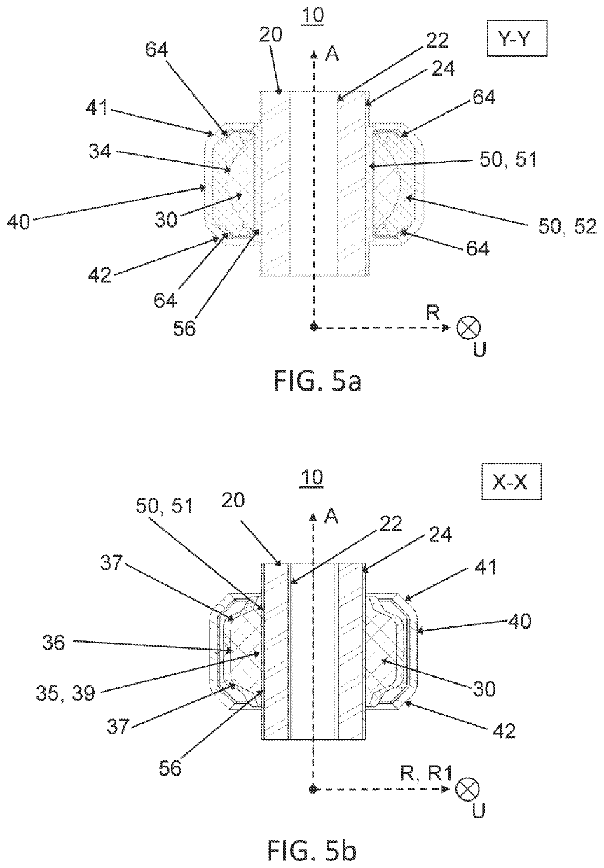

As exemplified in FIG. 4a, and illustrated by the further FIGS. 5a and 5b, the intermediate sleeve 30, aside from possible inner stop portions 35, may have a substantially constant diameter, that is, may in particular not have any radially inwardly directed bulge 33, in particular on a radial inner surface.

In alternative embodiments, the intermediate sleeve 30, according to the embodiment of the bearing bush 10 in FIG. 2a, may have a radially inwardly directed bulge 33, wherefor reference is made to the corresponding explanations with regard to FIGS. 2a, 2b, 3a and 3b.

As exemplified in FIG. 4a, the intermediate sleeve 30 may have a radially outwardly directed bulge 34, in particular on a radial outer surface, as explained analogously with regard to FIG. 2a. As further exemplified in FIG. 4a, the intermediate sleeve 30 may have one or more radially outwardly protruding outer stop portion(s) 36, in particular on a radial outer side, as explained analogously with regard to FIG. 2a.

As further exemplified in FIG. 4a, the intermediate sleeve 30 may in particular have a radially inwardly protruding inner stop portion 35 which forms an inner radial stop 39 with respect to a radial outer surface of the inner sleeve 20 or with respect to the outer circumferential surface 24 of the inner sleeve 20. The radially inwardly protruding inner stop portion 35 of the intermediate sleeve 30 is preferably arranged or formed within a region limited in the circumferential direction U. The radially inwardly protruding inner stop portion 35 of the intermediate sleeve 30 in particular protrudes further radially inwards than the radially inwardly directed bulge 33.

FIG. 4b shows an exploded view of the bearing bush 10 according to FIG. 4a.

As shown in FIGS. 4a and 4b, the intermediate sleeve 30 may have one or more openings 60. The opening 60 or the openings 60 may in particular be arranged or formed in a region of the intermediate sleeve 30 where the outer stop portion 36 and/or the inner stop portion 35 is arranged or formed.

The openings 60, on the one hand, in particular allow to avoid material accumulations at the intermediate sleeve 30, whereby blowholes or cavities in the intermediate sleeve 30 may be advantageously reduced or avoided, in particular in manufacture by means of injection molding. On the other hand, the openings 60 advantageously allow for the elastomer body to extend in and, in particular, through the openings 60 in the intermediate sleeve 30 when embedding the intermediate sleeve 30 in the elastomer body 50 and, in particular, when forming the elastomer body 50, whereby the embedding of the intermediate sleeve 30 in the elastomer body 50 may advantageously be improved, and a service life of the bearing bush 10 may advantageously be improved.

As shown by FIGS. 4a, 4b and 5b, the outer stop portion 36 or the outer stop portions 36 of the intermediate sleeve 30 may be oriented substantially along the first predetermined radial direction R1 in the circumferential direction U.

In preferred embodiments, and as illustrated by the sectional view in FIG. 5b, the intermediate sleeve 30 may have multiple outer stop portions 36 and may have multiple inner stop portions 35 which are respectively arranged or formed diametrically opposite one another on the intermediate sleeve 30.

FIG. 5a shows a first sectional view of the bearing bush 10 according to FIG. 4a along the Y-Y direction, that is, in a plane which is substantially spanned by the Y-Y direction and the axial direction A.

As shown in FIGS. 4a, 5a and 5b, the intermediate sleeve 30, aside from possible inner stop portions 35, may in particular have a substantially constant inner contour or a substantially constant inner diameter along the axial direction A, whereby the intermediate sleeve 30 is, one the hand, easily manufacturable and, on the other hand, may be linked to the inner sleeve 20 in a particularly fixed manner.

As further shown in FIGS. 4a, 4b and 5a, the intermediate sleeve 30 has in particular a radially outwardly directed bulge 34, as described analogously with regard to FIGS. 2a, 2b, 3a and 3b.

As compared to the first elastomer layer 51, as shown in FIG. 3a, the first elastomer layer 51, as shown in FIG. 5a, may in particular have a constant wall thickness along the axial direction A. Depending on possible inner stop portions 35 of the intermediate sleeve 30, the first elastomer layer 51 may in particular have a wall thickness varying in the circumferential direction U. The thinner the wall thickness or thickness of the respective elastomer layer 51, 52, the stiffer or more rigid the elastomer body 50 is at the respective location.

In exemplary embodiments, as shown in particular by FIGS. 4a to 5b as compared to FIGS. 2a to 3b, the first elastomer layer 51, in particular in a region of the intermediate sleeve 30 where no inner stop portion 35 is arranged or formed, may have a wall thickness of about 0.4 mm to about 2 mm, preferably of about 1 mm to about 1.5 mm, and thereby form a thin, and therefore particularly stiff, thin elastomer layer 56. In a region where the inner stop portion 35 is arranged, the first elastomer layer 51 may be even thinner than the thin elastomer layer 56, and may in particular have a wall thickness in the range of 0.2 mm to about 1 mm, and thereby be formed to be particularly stiff or secure a stiff link of the intermediate sleeve 30 to the inner sleeve 20.

While the first elastomer layer 51, which is comparatively thin in comparison with the second elastomer layer 52 and which, moreover, is also thin in comparison with the first elastomer layer 51 of the embodiment according to FIGS. 2a to 3b, allows for a particularly stiff link of the intermediate sleeve 30 to the inner sleeve 20, the comparatively thick second elastomer layer 52 secures a low cardanic stiffness and a low torsional stiffness, while at the same time a maximum deflection of the intermediate sleeve 30, and thus of the elastomer body 50, as illustrated by FIG. 5b, is advantageously limited by the inner stop portion 35 and/or the outer stop portion 36.

Here, the thickness of the first elastomer layer 51, as shown in FIGS. 4a, 5a and 5b, is so thin that the intermediate sleeve 30 may be assumed to be almost rigidly connected to the inner sleeve 20. The first elastomer layer 51, according to FIGS. 4a, 5a and 5b, therefore causes an increase in the axial stiffness, the cardanic stiffness and the torsional stiffness in comparison with the first elastomer layer 51, according to FIGS. 2a, 2b, 3a and 3b, wherein it should still be emphasized that in particular the cardanic stiffness and the torsional stiffness is still lower than in a conventional bearing bush which does not have a bulged intermediate sleeve.

FIG. 5b shows a second sectional view of the bearing bush 10 according to FIG. 4a along the X-X direction or the first predetermined radial direction R1, that is, in a plane which is substantially spanned by the X-X direction and the axial direction A.

As shown in FIG. 5b, the intermediate sleeve 30 may have multiple outer stop portions 36 (in FIG. 5b, illustrated only on the left with reference numeral for the sake of clarity, but present on the right as well) which are arranged or formed diametrically opposite one another on the intermediate sleeve 30, and may have multiple inner stop portions 35 (in FIG. 5b, illustrated only on the left with reference numeral for the sake of clarity, but present on the right as well) which are arranged or formed diametrically opposite one another on the intermediate sleeve 30.

The inwardly protruding inner stop portions 35 and/or the outwardly protruding outer stop portions 36 which may be arranged diametrically opposite one another, respectively, as shown in FIG. 5b, may in particular be arranged like the respective inner and/or outer stop portions 35, 36, as explained with regard to the respective FIGS. 2a, 2b, 3a and 3b, so that reference is made to the statements regarding these.

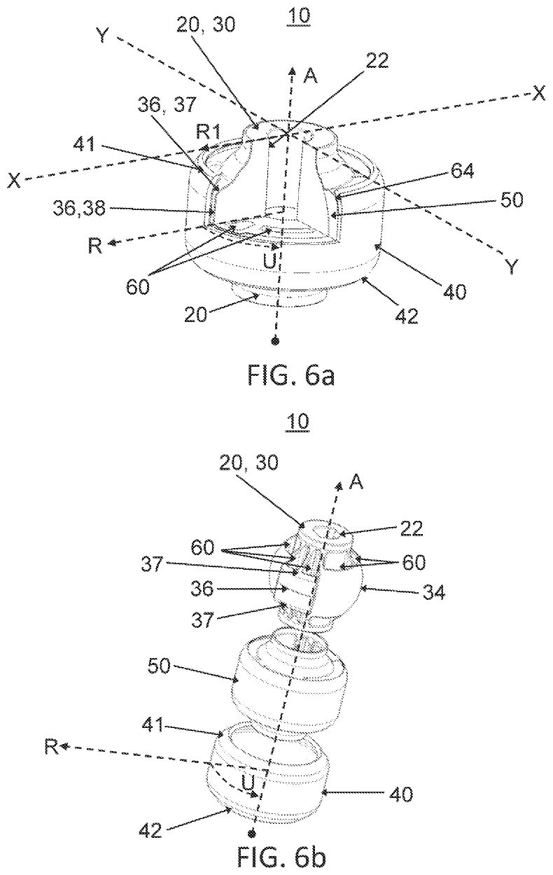

FIG. 6a shows a perspective view of another bearing bush 10 according to an embodiment of the present disclosure in a partially sectioned illustration.

The bearing bush 10, as shown in FIG. 6a, comprises in particular an inner sleeve 20 and further an intermediate sleeve 30 which is arranged between the inner sleeve 20 and the outer sleeve 40, and as compared to the embodiments based on FIGS. 2a and 4a, is formed integrally with the inner sleeve 20 or is arranged directly thereon. The intermediate sleeve 30 is, at least in sections, embedded in the elastomer body 50.

As shown in FIG. 6a, the inner sleeve 20 may in particular have a substantially constant inner diameter. As compared to the embodiments according to FIGS. 2a and 4a, the inner sleeve 20 or the intermediate sleeve 30 formed in one piece with the inner sleeve 20 has an outer diameter or cross-section varying along the axial direction A. As exemplified in FIG. 6a, the inner sleeve 20 formed integrally with the intermediate sleeve 30 may have a radially outwardly directed bulge 34, in particular on a radial outer surface. As further exemplified in FIG. 6a, the intermediate sleeve 30 or the inner sleeve 20 formed integrally therewith may have a radially outwardly protruding outer stop portion 36, in particular on a radial outer side.

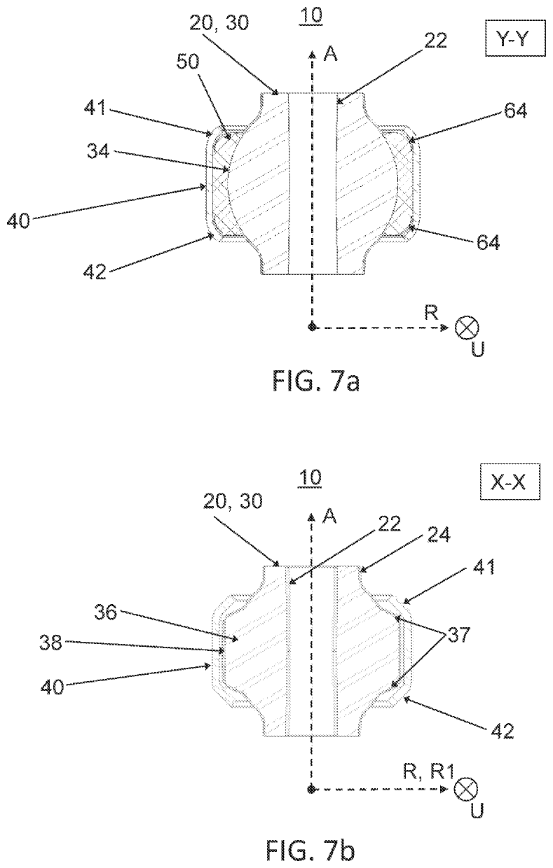

As shown in FIG. 6a and further illustrated by FIG. 7b, the radially outwardly protruding outer stop portion 36 forms an undercut relative to the outer sleeve 40, in particular relative to the at least one bend portion 41, 42 of the outer sleeve 40, in the axial direction A. If the intermediate sleeve 30 or the inner sleeve 20 formed integrally therewith is deflected by a predetermined amount in the axial direction A when damping a load which acts on the bearing bush 10, the radially outwardly protruding outer stop portion 36 strikes in particular against an axial inner surface of one of the bend portions 41, 42, that is, in particular against an inner circumferential side of the outer sleeve 40, which faces the outer stop portion 36 in the axial direction A. The outer stop portion 36 therefore in particular forms an axial stop 37 relative to the outer sleeve 40.

Thereby, the bearing bush 10 having application-specific damping properties may advantageously be provided, wherein the bearing bush 10 provides different damping properties from one region to another, in particular depending on the deflection of the intermediate sleeve 30 or the inner sleeve 20 formed integrally therewith in the bearing bush 10. Since, moreover, in particular the inner sleeve 20, integrally with the intermediate sleeve 30, and/or the outer sleeve 40 are advantageously easily producible, by virtue of the present bearing bush 10, an easily and efficiently manufacturable bearing bush 10 in which the damping properties are advantageously precisely adjustable may advantageously be provided.

As further shown in FIG. 6a and illustrated in FIG. 7b, in exemplary embodiments, the outer stop portion 36 may form an outer radial stop 38 with respect to the outer sleeve 40, in particular with respect to a radial inner surface of the outer sleeve 40. As compared to the embodiments according to FIGS. 2a and 4a, the bearing bush 10 according to FIG. 6a in particular does not have an inner stop portion 35.

FIG. 6b shows an exploded view of the bearing bush 10 according to FIG. 6a.

As compared to the bearing bush 10 according to FIGS. 2a and 4a, the bearing bush 10 according to FIGS. 6a and 6b comprises in particular an intermediate sleeve 30 formed in one part or in one piece with the inner sleeve 20. As shown in FIGS. 6a and 6b, the intermediate sleeve 30 or the inner sleeve 20 formed integrally therewith may have one or more openings 60. The opening 60 or the openings 60 may in particular be arranged or formed in a region of the intermediate sleeve 30 or the inner sleeve 20 formed integrally therewith where the outer stop portion 36 is arranged or formed. The openings 60 allow for the same advantages as those emphasized with regard to FIGS. 4a to 5b, so that reference is made thereto.

As shown by FIGS. 6a, 6b and 7b, the outer stop portion 36 or the outer stop portions 36 of the intermediate sleeve 30 or the inner sleeve 20 formed integrally therewith may be oriented substantially along the first predetermined radial direction R1 in the circumferential direction U, as exemplarily illustrated in FIGS. 6a and 7b also by the X-X direction.

In preferred embodiments, and as illustrated by the sectional view in FIG. 7b, the intermediate sleeve 30 or the inner sleeve 20 formed integrally therewith may have multiple outer stop portions 36 which are arranged or formed diametrically opposite one another on the intermediate sleeve 30.

FIG. 7a shows a first sectional view of the bearing bush 10 according to FIG. 6a along the Y-Y direction, that is, in a plane which is substantially spanned by the Y-Y direction, as shown in FIG. 6a, and the axial direction A.

As shown in FIGS. 6a, 7a and 7b, the inner sleeve 20 may in particular have a substantially constant inner diameter, whereby the inner sleeve 20 is easy to manufacture. As further shown in FIGS. 6a, 6b and 7a, the intermediate sleeve 30 or the inner sleeve 20 formed integrally therewith has in particular a radially outwardly directed bulge 34, wherein the intermediate sleeve 30 or the inner sleeve 20 formed integrally therewith has an increasing outer diameter, that is, an outer diameter becoming larger, on a side facing the outer sleeve 40, towards an axial center, so that the intermediate sleeve 30 or the inner sleeve 20 formed integrally therewith is given a crowned shape. At a central position in the axial direction A of the intermediate sleeve 30 or the inner sleeve 20 formed integrally therewith, the intermediate sleeve 30 or the inner sleeve 20 formed integrally therewith, in exemplary embodiments, may accordingly have a largest outer diameter.

As compared to the embodiments according to FIGS. 2a and 4a, the elastomer body 50 according to FIGS. 6a, 6b, 7a and 7b is in particular substantially formed with a single layer, wherein this preferably does not exclude that the elastomer body 50 extends, at least partially, in or through the openings 60, as shown in FIGS. 6a and 6b.

FIG. 7b shows a second sectional view of the bearing bush 10 according to FIG. 6a along the X-X direction or the first predetermined radial direction R1, that is, in a plane which is substantially spanned by the X-X direction and the axial direction A.

As shown in FIG. 7b, the intermediate sleeve 30 or the inner sleeve 20 formed integrally therewith may have multiple outer stop portions 36 (in FIG. 7b, illustrated only on the left with reference numeral for the sake of clarity, but present on the right as well) which are arranged or formed diametrically opposite one another on the intermediate sleeve 30 or the inner sleeve 20 formed integrally therewith.

The outer stop portions 36 each form an axial stop 37 with respect to the axial inner surfaces of the bend portions 41, 42 in the axial direction A, so that the deflection of the intermediate sleeve 30 or the inner sleeve 20 formed integrally therewith in the axial direction A relative to the outer sleeve 40, and thereby accordingly the deformation of the elastomer body 50, is advantageously limited.

The outer stop portions 36 may further each form an outer radial stop 38 with respect to the radial inner surfaces of the outer sleeve 40 in the radial direction R, so that the deflection of the intermediate sleeve 30 or the inner sleeve 20 formed integrally therewith in the radial direction R relative to the outer sleeve 40, and thereby accordingly the deformation of the elastomer body 50, is advantageously limited.

The outwardly protruding stop portions 36 which may be arranged diametrically opposite one another, as shown in FIGS. 6a, 6b and 7b, may in particular be arranged like the stop portions 36, as explained with regard to the respective FIGS. 2a, 2b, 3a, 3b, 4a, 4b, 5a and 5b, so that reference is made to the statements regarding these.

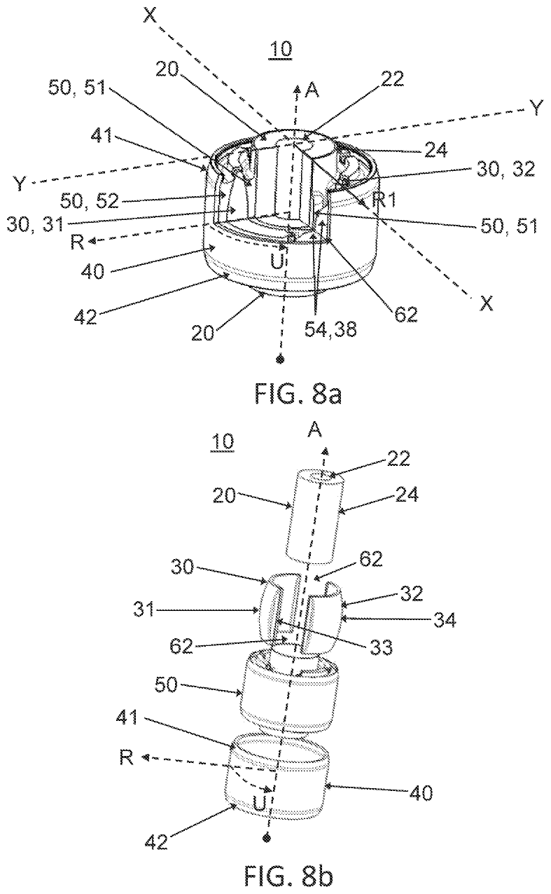

FIG. 8a shows a perspective view of another bearing bush 10 according to an embodiment of the present disclosure in a partially sectioned illustration.

The intermediate sleeve 30, as shown in FIG. 8a, is in particular formed in multiple pieces and may accordingly comprise multiple intermediate sleeve parts 31, 32, in particular comprise two, three, four, five or six intermediate sleeve parts.

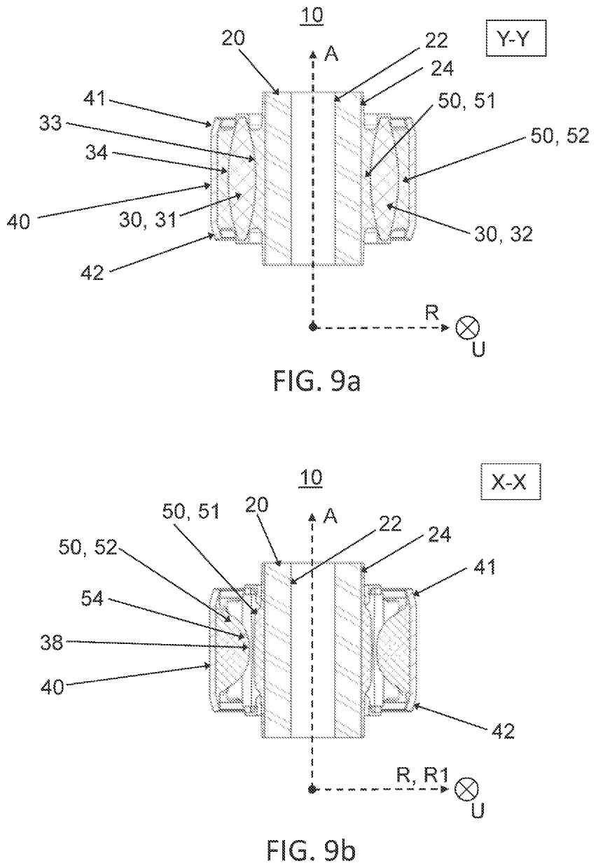

As exemplified in FIG. 8a, the intermediate sleeve 30 and, accordingly, at least one of the first intermediate sleeve part 31 and the second intermediate sleeve part 32, has a radially inwardly directed bulge 33 on a radial inner surface, wherefor reference is made to the respective analogous statements with regard to FIGS. 2a to 3b. As further exemplified in FIG. 8a and further illustrated in FIGS. 8b and 9a, the intermediate sleeve 30 and, accordingly, at least one of the first intermediate sleeve part 31 and the second intermediate sleeve part 32, has a radially outwardly directed bulge 34 on a radial outer surface, wherefor reference is made to the respective analogous statements with regard to FIGS. 2a to 3b.

As further exemplified in FIG. 8a and illustrated by a comparison between FIGS. 9a and 9b, the elastomer body 50 and, accordingly, at least one of the first elastomer layer 51 and the second elastomer layer 52, may radially protrude in a region of the spacing 62 between the first intermediate sleeve part 31 and the second intermediate sleeve part 32, in particular, at least partially, radially into the spacing 62 or radially through the spacing 62. In this case, an elastomeric stop portion 54 of the at least one of the first elastomer layer 51 and the second elastomer layer 52 radially protrudes towards the other of the first elastomer layer 51 and the second elastomer layer 52.

In FIGS. 8a and 9b, the elastomeric stop portion 54 is illustrated to be formed with the second elastomer layer 52 of the elastomer body 50. In alternative embodiments, the elastomeric stop portion 54 may be formed with the first elastomer layer 51 of the elastomer body 50.

The radially protruding elastomeric stop portion 54 may, in other words, in particular radially protrude, with respect to the first elastomer layer 51 or the second elastomer layer 52, to the other of the first elastomer layer 51 and the second elastomer layer 52, preferably within a region limited in the circumferential direction U, in particular within the spacing 62 between the respective intermediate sleeve parts adjacent to each other in the circumferential direction U, that is, in particular between the first intermediate sleeve part 31 and the second intermediate sleeve part 32.

As shown in FIG. 8a and further illustrated by FIG. 9b, the radially protruding elastomeric stop portion 54 of the elastomer body 50 forms a stop portion in the radial direction R, that is, in the case of a radially inwardly protruding elastomeric stop portion 54, an inner radial stop 39, and in the case of a radially outwardly protruding elastomeric stop portion 54, an outer radial stop 38, relative to the respective first or second elastomer layer 51, 52.

If the inner sleeve 20 and the outer sleeve 40 are deflected relative to each other by a predetermined amount in the radial direction R upon receiving a load which acts on the bearing bush 10, the radially protruding elastomeric stop portion 54 may strike against a surface of the elastomer body 50 radially facing the elastomeric stop portion 54, or against a surface of the inner sleeve 20 or outer sleeve 40 facing the elastomeric stop portion 54.

FIG. 8b shows an exploded view of the bearing bush 10 according to FIG. 8a.

As exemplarily illustrated in FIG. 8b, the intermediate sleeve 30 is in particular formed in multiple parts or in multiple pieces, wherefor reference is made to the corresponding statements with regard to FIGS. 2a to 3b, in particular FIG. 2b. As shown by FIGS. 8a, 8b and 9b, the elastomeric stop portion 54 or the elastomeric stop portions 54 of the elastomer body 50 may be oriented substantially along the first predetermined radial direction R1 in the circumferential direction U, as exemplarily illustrated in FIGS. 8a and 9b also by the X-X direction.

In preferred embodiments, and as illustrated by the sectional view in FIG. 9b, the elastomer body 50 may have multiple elastomeric stop portions 54 which are arranged or formed diametrically opposite one another on the elastomer body 50. Thereby, the bearing bush 10 may advantageously be provided with damping properties specific to the circumferential direction U which, moreover, are advantageously precisely adjustable by the formation of the elastomeric stop portions 54.

FIG. 9a shows a first sectional view of the bearing bush 10 according to FIG. 9a along the Y-Y direction, that is, in a plane which is substantially spanned by the Y-Y direction, as shown in FIG. 9a, and the axial direction A.

As further shown in FIG. 9a, the elastomer body 50 has in particular a first elastomer layer 51 facing the inner sleeve 20 and a second elastomer layer 52 facing the outer sleeve 40, wherein the first elastomer layer 51 is separated, at least in sections, from the second elastomer layer 52 by the intermediate sleeve 30. The first elastomer layer 51 and/or the second elastomer layer 52 may have a varying wall thickness or thickness along the axial direction A, in particular depending on the contour of the intermediate sleeve 30 and the contours of the inner circumferential side of the outer sleeve 40 and the outer circumferential side of the inner sleeve 20.

In still further exemplary embodiments, as shown in particular by FIG. 9b, the second elastomer layer 52 may have a wall thickness of about 8 mm to about 22 mm in a region where the elastomeric stop portion 54 is arranged or formed on the second elastomer layer 52.

Furthermore, the first elastomer layer 51 may have a wall thickness of about 1 mm to about 16 mm, preferably of about 1.5 mm to about 10 mm, in a region where the elastomeric stop portion 54 is arranged or formed on the second elastomer layer 52. It is to be understood that correspondingly larger or smaller-scaled bearing bushes 10 may have correspondingly larger or smaller wall thicknesses, in particular with regard to the first elastomer layer 51 and/or the second elastomer layer 52. By means of the thickness ratio or the wall thickness ratio between the first elastomer layer 51 and the second elastomer layer 52 in a region where the elastomeric stop portion 54 is arranged or formed on the second elastomer layer 52 or the first elastomer layer, the stiffness and damping properties of the bearing bush 10 are advantageously adjustable in terms of striking of the elastomeric stop portion 54.

As shown by FIGS. 8a and 9a, the first elastomer layer 51 and the second elastomer layer 52 of the elastomer body 50 may in particular be connected to each other at axial ends of the intermediate sleeve 30.

FIG. 9b shows a second sectional view of the bearing bush 10 according to FIG. 8a along the X-X direction or the first predetermined radial direction R1, that is, in a plane which is substantially spanned by the X-X direction and the axial direction A.

As shown in FIG. 9b, the elastomer body 50 may have multiple elastomeric stop portions 54 (in FIG. 9b, illustrated only on the left with reference numeral for the sake of clarity, but present on the right as well) which are arranged or formed diametrically opposite one another on the elastomer body 50. The elastomeric stop portions 54 each form a radial stop 38, 39 with respect to the surfaces of the elastomer body 50 radially facing the respective elastomeric stop portion 54 in the radial direction R, depending on whether the elastomeric stop portion 54 is arranged or formed on the radially outer second elastomer layer 52 or the radially inner first elastomer layer 51.

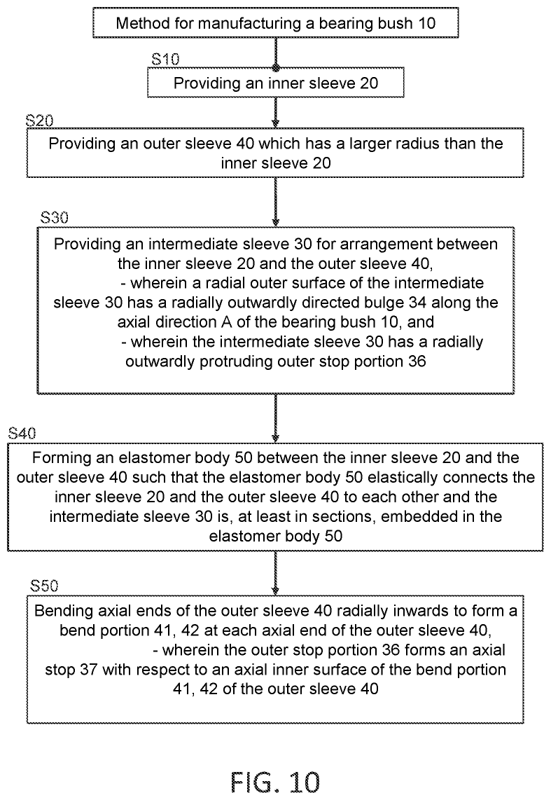

FIG. 10 shows a flowchart of a method for manufacturing a bearing bush 10 according to an embodiment of the present disclosure, in particular according to the bearing bush 10, as shown in FIGS. 2a to 7b.

The method comprises the following steps, in particular in this exact order:

S10: Providing an inner sleeve 20.

S20: Providing an outer sleeve 40 which has a larger radius than the inner sleeve 20.

S30: Providing an intermediate sleeve 30 for arrangement between the inner sleeve 20 and the outer sleeve 40, wherein a radial outer surface of the intermediate sleeve 30 has a radially outwardly directed bulge 34 along the axial direction A of the bearing bush 10, and wherein the intermediate sleeve 30 has a radially outwardly protruding outer stop portion 36.

S40: Forming an elastomer body 50 between the inner sleeve 20 and the outer sleeve 40 such that the elastomer body 50 elastically connects the inner sleeve 20 and the outer sleeve 40 to each other and the intermediate sleeve 30 is, at least in sections, embedded in the elastomer body 50.

S50: Bending axial ends of the outer sleeve 40 radially inwards to form a bend portion 41, 42 at each axial end of the outer sleeve 40, wherein the outer stop portion 36 forms an axial stop 37 with respect to an axial inner surface of the bend portion 41, 42 of the outer sleeve 40.

In preferred embodiments, step S50 in particular is performed after step S40, whereby possible tensile stresses in the elastomer body 50 may be reduced, and advantageously compressive prestresses may be applied to the elastomer body 50, whereby the service life of the elastomer body 50 of the bearing bush 10 is advantageously improved, respectively.

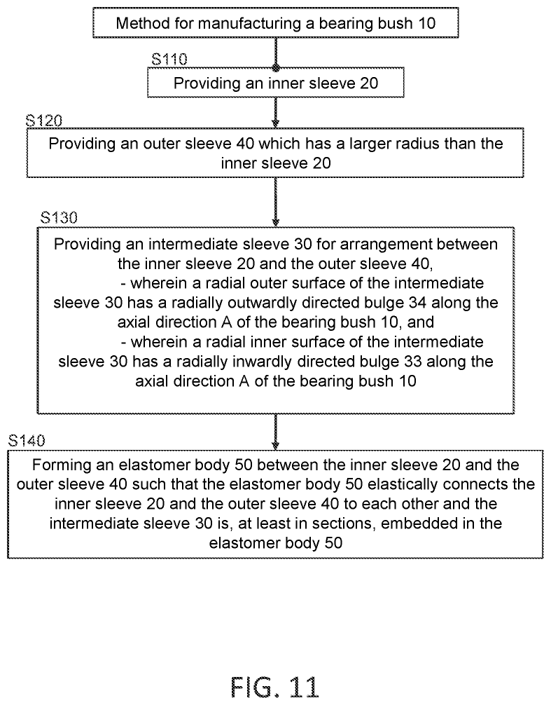

FIG. 11 shows a flowchart of a method for manufacturing a bearing bush 10 according to an embodiment of the present disclosure, in particular according to the bearing bush 10, as shown in FIGS. 8a to 9b.

The method comprises the following steps, in particular in this exact order:

S110: Providing an inner sleeve 20.

S120: Providing an outer sleeve 40 which has a larger radius than the inner sleeve 20.

S130: Providing an intermediate sleeve 30 for arrangement between the inner sleeve 20 and the outer sleeve 40, wherein a radial outer surface of the intermediate sleeve 30 has a radially outwardly directed bulge 34 along the axial direction A of the bearing bush 10, and wherein a radial inner surface of the intermediate sleeve 30 has a radially inwardly directed bulge 33 along the axial direction A of the bearing bush 10.

S140: Forming an elastomer body 50 between the inner sleeve 20 and the outer sleeve 40 such that the elastomer body 50 elastically connects the inner sleeve 20 and the outer sleeve 40 to each other and the intermediate sleeve 30 is, at least in sections, embedded in the elastomer body 50.

In exemplary embodiments of the method according to FIG. 11, the method may comprise a step 150:

S150: Bending axial ends of the outer sleeve 40 radially inwards to form a bend portion 41, 42 at each axial end of the outer sleeve 40.

Here, in preferred embodiments, step S150 may be performed after step S140. Thereby, possible tensile stresses may be reduced in the elastomer body 50 and compressive prestresses may advantageously be applied to the elastomer body 50, whereby the service life of the elastomer body 50 of the bearing bush 10 is advantageously improved, respectively.

In at least one of the methods according to steps S10 to S50 or S10 to S140 or S150:

Before step S10 or S110, a step of manufacturing the inner sleeve 20 may be performed, wherein the inner sleeve 20 is preferably manufactured by means of extrusion, pultrusion or die casting, preferably from or with aluminum and alternatively from or with steel, and preferably such that the inner sleeve 20 has a constant cross-section; and/or

Before step S20 or S120, a step of manufacturing the outer sleeve 40 may be performed, wherein the outer sleeve 40 is preferably manufactured by means of extrusion, pultrusion or die casting, preferably from or with aluminum and alternatively from or with steel, and preferably such that the outer sleeve 40 has a constant cross-section; and/or before step S30 or S130, a step of manufacturing the intermediate sleeve 30 may be performed, wherein the intermediate sleeve 30 is preferably manufactured by means of injection molding or die casting, preferably from or with plastic, in particular fiber-reinforced plastic such as, for example, polyamide or glass fiber-reinforced polyamide, and alternatively from or with aluminum, and preferably such that the intermediate sleeve 30 has a crowned shape, in particular with a radially outwardly directed bulge 34 along the axial direction A; or before step S30 or S130, a step of manufacturing the intermediate sleeve 30 in multiple pieces or in multiple parts may be performed, wherein the intermediate sleeve 30 is manufactured as multiple intermediate sleeve parts 31, 32, preferably by means of injection molding or die casting, preferably from or with plastic, in particular fiber-reinforced plastic such as, for example, polyamide or glass fiber-reinforced polyamide, and alternatively from or with aluminum, and preferably such that the intermediate sleeve parts 31, 32 have a crowned shape, in particular with a radially outwardly directed bulge 34 along the axial direction A.

1. A bearing bush, in particular for a transverse control arm of a vehicle, the bearing bush comprising:
an inner sleeve;
an outer sleeve which is arranged radially around the inner sleeve;
an elastomer body which is arranged between the inner sleeve and the outer sleeve and elastically connects them to each other; and
an intermediate sleeve which is, at least in sections, embedded in the elastomer body,
wherein the outer sleeve has, at its axial ends, a radially inwardly bent bend portion, respectively;
wherein a radial outer surface of the intermediate sleeve has a radially outwardly directed bulge along an axial direction of the bearing bush, and
wherein the intermediate sleeve has a radially outwardly protruding outer stop portion which forms an axial stop with respect to an axial inner surface of the bend portion of the outer sleeve.

2. The bearing bush according to claim 1, wherein the inner sleeve has a substantially constant cross-section along the axial direction.

3. The bearing bush according to claim 1, wherein a radial inner surface of the intermediate sleeve has a radially inwardly directed bulge along the axial direction of the bearing bush.

4. The bearing bush according to claim 1, wherein the intermediate sleeve is directly connected to the inner sleeve, wherein the intermediate sleeve is in particular formed in one piece with the inner sleeve,
or wherein a thin elastomer layer is so thin between the intermediate sleeve and the inner sleeve that the intermediate sleeve is substantially rigidly connected to the inner sleeve.

5. The bearing bush according to claim 1, wherein the intermediate sleeve has a radially inwardly protruding inner stop portion which forms an inner radial stop with respect to a radial outer surface of the inner sleeve.

6. The bearing bush according to claim 1, wherein the inwardly bent bend portions of the outer sleeve are inwardly bent after vulcanizing the elastomer body.

7. A bearing bush for use with a transverse control arm of a vehicle, the bearing bush comprising:
an inner sleeve;
an outer sleeve which is arranged radially around the inner sleeve;
an elastomer body which is arranged between the inner sleeve and the outer sleeve and elastically connects them to each other; and
an intermediate sleeve which is, at least in sections, embedded in the elastomer body,
wherein a radial outer surface of the intermediate sleeve has a radially outwardly directed bulge along the axial direction of the bearing bush, and
wherein a radial inner surface of the intermediate sleeve has a radially inwardly directed bulge along the axial direction of the bearing bush.

8. The bearing bush according to one claim 1, wherein the intermediate sleeve is a plastic component and/or is an aluminum component, or
wherein the intermediate sleeve is an iron or cast steel component and/or is a sintered component.

9. The bearing bush according to claim 1, wherein the intermediate sleeve is multipart,
wherein the intermediate sleeve comprises in particular two half shells, wherein each half shell has one outer stop portion, respectively, at the ends in the circumferential direction.

10. A method for manufacturing a bearing bush for use with a transverse control arm of a vehicle, the method comprising the steps of:
providing an inner sleeve;
providing an outer sleeve which has a larger radius than the inner sleeve;
providing an intermediate sleeve for arrangement between the inner sleeve and the outer sleeve,
wherein a radial outer surface of the intermediate sleeve has a radially outwardly directed bulge along the axial direction of the bearing bush, and
wherein the intermediate sleeve has a radially outwardly protruding outer stop portion,
forming an elastomer body between the inner sleeve and the outer sleeve such that the elastomer body elastically connects the inner sleeve and the outer sleeve to each other and the intermediate sleeve is, at least in sections, embedded in the elastomer body;
bending axial ends of the outer sleeve radially inwards to form a bend portion at each axial ends of the outer sleeve,
wherein the outer stop portion forms an axial stop with respect to an axial inner surface of the bend portion of the outer sleeve.

11. A method for manufacturing a bearing bush for use with a transverse control arm of a vehicle, the method comprising the steps of:
providing an inner sleeve;
providing an outer sleeve which has a larger radius than the inner sleeve;
providing an intermediate sleeve for arrangement between the inner sleeve and the outer sleeve,
wherein a radial outer surface of the intermediate sleeve has a radially outwardly directed bulge along the axial direction of the bearing bush, and
wherein a radial inner surface of the intermediate sleeve has a radially inwardly directed bulge along the axial direction of the bearing bush,
forming an elastomer body between the inner sleeve and the outer sleeve such that the elastomer body elastically connects the inner sleeve and the outer sleeve to each other and the intermediate sleeve is, at least in sections, embedded in the elastomer body.

12. The method for manufacturing a bearing bush according to claim 11, further including at least one of the steps of:
extruding, diecasting or continuously casting the inner sleeve;
extruding or continuously casting the outer sleeve; and
injection molding or diecasting the intermediate sleeve.
